(19) United States
(12) Patent Application Publication
(10) Pub. No.: US 2026/0324588 A1
(43) Pub. Date: Oct. 22, 2026

(54) ARTIFICIAL TEAT FOR FEEDING ANIMALS

(71) Applicant: Skellerup Industries Limited, Christchurch (NZ)

(72) Inventors: Dino Michael KUDRASS, Christchurch (NZ); Daniel Steven Paris, Christchurch (NZ); Samuel Purdy, Christchurch (NZ); Andreas Wolfgang Hoffman, Christchurch (NZ)

(73) Assignee: Skellerup Industries Limited, Christchurch (NZ)

(21) Appl. No.: 19/689,166

(22) Filed: May 27, 2026

Related U.S. Application Data
(63) Continuation-in-part of application No. PCT/IB2025/061212, filed on Nov. 4, 2025.

(30) Foreign Application Priority Data
Nov. 4, 2024 (AU) 2024903599
May 27, 2025 (AU) 2025203932

(51) Int. Cl. A01K 9/00

(52) U.S. Cl. CPC A01K 9/005

(57) ABSTRACT

An artificial feeding teat for ducting a liquid from a liquid reservoir to an animal for oral consumption by the animal is provided. The artificial feeding teat comprises a shaft with an elongate straight axis that is hollow to define a duct for the liquid to flow through, a base located at a first distal end of the shaft defining an inlet opening to the duct, and a nipple located at a second distal end opposite of the first distal end, the nipple has a nipple wall to define a closure to the duct at the end of the second distal end of the shaft, save for at least one closeable opening through the nipple wall.

### CROSS REFERENCE TO RELATED APPLICATIONS

This current application is bypass continuation-in-part of PCT International Application No. PCT/IB2025/061212 filed on Nov. 4, 2025, which claims priority to, and enjoys the benefit of, Australian Application No. 2024903599 filed on Nov. 4, 2024. Further, this current application also claims priority to, and enjoys the benefit of, Australian Application No. 2025203932 filed on May 27, 2025. The entire disclosures of these earlier-filed applications are incorporated herein by reference for all purposes.

### FIELD

The disclosure relates to artificial feeding teats for feeding animals, and particularly to artificial feeding teats suitable for feeding young animals from animal feeding equipment.

### BACKGROUND

Farming practices commonly involve artificially feeding young animals such as calves, goat kids, and lambs. This can occur from a young age, for example when animals are separated at an early age from their mothers.

An artificial feeding teat can be made of a resilient material and can be secured to a reservoir, bottle, feeder, feeding bar, feeder arm, drum, or another source of liquid for feeding the animal. The animal can latch onto the artificial feeding teat and draw liquid from the source through a duct of the artificial feeding teat and through a closeable opening at a nipple end of the artificial feeding teat.

When the animal is not drawing liquid from the artificial feeding teat, resistance to leakage at the closeable opening at the nipple end can be desirable. Leakage can occur where liquid in the artificial feeding teat is subject to a pressure head, where a flexible reservoir is squeezed, or where other pressure conditions urge liquid toward the closeable opening.

Artificial feeding teats and the reservoir interfaces to which they are engaged can also be subject to wear or displacement during use. The animal can apply lateral, longitudinal, rotational, shear, or other forces to the artificial feeding teat during feeding. These forces can wear a seal between the artificial feeding teat and the reservoir, can alter a rotational orientation of the artificial feeding teat relative to the reservoir, or can dislodge the artificial feeding teat from the reservoir.

In some arrangements, a rotational orientation of a closeable opening at the nipple end can affect feeding performance or leakage. For example, where the closeable opening comprises an elongate slit, maintaining the slit in a desired rotational orientation can assist with dispensing liquid to the animal and reducing spillage.

Embodiments described herein provide artificial feeding teats, reservoirs, and feeding systems that address one or more of these issues, or at least provide the public with a useful choice.

### SUMMARY OF THE INVENTION

In a first aspect the present invention may be said to be an artificial feeding teat for ducting a liquid from a liquid reservoir to an animal for oral consumption of the liquid by the animal, the artificial feeding teat comprising:
a shaft having an elongate straight axis, the shaft being hollow to define a duct for the liquid to flow through;
a base located at a first distal end of the shaft and defining an inlet opening to the duct, the base comprising a peripheral seal configured to releasably engage a seat defined at an opening of the liquid reservoir to provide sealed fluid communication from the liquid reservoir through the opening and into the duct; and
a nipple located at a second distal end of the shaft opposite the first distal end, the nipple having a nipple wall defining a closure to the duct at the second distal end, apart from at least one closeable opening through the nipple wall;
wherein the peripheral seal comprises a peripheral surface having a non-circular geometry in a cross-sectional plane perpendicular to the elongate straight axis, the non-circular geometry having one or two lines of symmetry and being configured to mate with a complementary non-circular geometry of a corresponding peripheral surface of the seat to prevent clockwise and anticlockwise rotation of the artificial feeding teat about the elongate straight axis when the base is engaged with the liquid reservoir; and
wherein the closeable opening comprises an elongate slit, and the non-circular geometry is configured to locate the elongate slit at a predetermined rotational position about the elongate straight axis when the base is engaged with the liquid reservoir.

In one aspect, an artificial feeding teat is provided for ducting a liquid from a liquid reservoir to an animal for oral consumption of the liquid by the animal. The feeding teat comprises a shaft with an elongate straight axis. The shaft is hollow to define a duct for the liquid to flow through. A base is located at a first distal end of the shaft and defines an inlet opening to the duct. A nipple is located at a second distal end opposite the first distal end. The nipple has a nipple wall to define a closure to the duct at the second distal end of the shaft, save for at least one closeable opening through the nipple wall. The base defines a peripheral seal that is configured to releasably engage with a seat defined at an opening to the liquid reservoir to allow sealed ducting of the liquid from the reservoir through the opening and into the duct. An interface of the feeding teat and the reservoir is configured to prevent clockwise and anticlockwise rotation of the feeding teat about the axis when the base is engaged to the reservoir. The peripheral seal comprises a peripheral surface which engages with a corresponding peripheral surface of the seat. The peripheral surface comprises a non-circular geometry having one or two lines of symmetry in a cross-sectional plane to which the axis is normal and is adapted to engage with a complementary non-circular geometry of the peripheral surface of the seat. The closeable opening comprises an elongate slit extending in another cross-sectional plane to which the axis is normal. The interface is configured to secure the elongate slit at a predetermined rotational position about the axis when the base is engaged to the reservoir.

In some embodiments, the peripheral surface comprises a longitudinal surface extending substantially parallel to the axis and perimetrically around the feeding teat to engage with a corresponding longitudinal surface of the seat. In some embodiments, the peripheral surface comprises a radial surface extending radially from an end of the longitudinal surface to engage with a corresponding radial surface of the seat. In some embodiments, the peripheral surface comprises a second radial surface extending radially from the other end of the longitudinal surface to engage with a corresponding second radial surface of the seat. In some embodiments, the interface is configured to secure the elongate slit substantially vertically when the base is engaged to the reservoir.

In some embodiments, the non-circular geometry comprises one of the following shapes: rectangle, rounded rectangle, semi-circle, ellipse, triangle, trapezoid, parallelogram, a circle save for at least one straight line edge, a spline, or a keyway. In some embodiments, the interface of the seal and seat is a keyed interface. In some embodiments, the seal comprises at least one ridge or groove extending parallel to the axis and adapted to engage with a complementary groove or ridge in the seat. In some embodiments, the feeding teat comprises a projection or recess adjacent the seal and radially spaced from the axis and adapted to engage with a complementary recess or projection of the reservoir. In some embodiments, the projection and recess are configured to engage using a keyed interface.

In some embodiments, the closeable opening through the nipple wall is deformable between a natural state where the nipple wall at the opening compressively seals the opening and a deformed state that creates an opening through the nipple wall via which liquid can pass from the duct to the animal. In some embodiments, the feeding teat has a second closeable opening comprising a second slit which extends in a second direction parallel to a second plane passing through the axis, and a component of the first and second directions perpendicular to the axis are substantially colinear. In some embodiments, the interface is configured to align a component of the or each slit perpendicular to the axis such that the component is coextensive with a predetermined radial of the axis when the base is engaged to the reservoir. In some embodiments, the predetermined radial corresponds with a vertical alignment of the component of the or each slit perpendicular to the axis.

In some embodiments, the feeding teat is a push-through or a pull-through feeding teat. In some embodiments, the seal comprises a screw thread extending helically about the axis and adapted to engage with a complementary screw thread of the seat. In some embodiments, in a cross-sectional plane to which the axis is normal, the shaft is of a circular exterior shape. In some embodiments, the base defines a base axis along which the base is translated to engage with the opening of the reservoir, and the longitudinal axis of the shaft extends in a plane passing through the base axis, the plane being angled between 0 and 90 degrees from the base axis.

In another aspect, a reservoir is provided for feeding an animal. The reservoir is configured for storing a liquid for oral consumption by the animal. The reservoir comprises a seat defined at an opening to the reservoir and configured to releasably engage with a base defining a peripheral seal of an elongate artificial feeding teat to allow sealed ducting of the liquid from the reservoir through the opening into the feeding teat for oral consumption by the animal. An interface of the reservoir and the feeding teat is configured to prevent clockwise and anticlockwise rotation of the feeding teat about a longitudinal axis of the feeding teat when the base of the feeding teat is engaged to the reservoir. The seat comprises a peripheral surface which engages with a corresponding peripheral surface of the seal. The peripheral surface of the seat comprises a non-circular geometry having one or two lines of symmetry in a cross-sectional plane to which the axis is normal when the base is engaged to the reservoir. The peripheral surface of the seat is adapted to engage with a complementary non-circular geometry of the peripheral surface of the seal. The interface is configured to secure the feeding teat at a predetermined rotational position about the axis when the feeding teat is engaged to the reservoir.

In some embodiments of the reservoir, the peripheral surface of the seat comprises a longitudinal surface extending substantially parallel to the axis and perimetrically around the seat to engage with a corresponding longitudinal surface of the seal. In some embodiments, the peripheral surface comprises a radial surface extending radially from an end of the longitudinal surface to engage with a corresponding radial surface of the seal. In some embodiments, the peripheral surface comprises a second radial surface extending radially from the other end of the longitudinal surface to engage with a corresponding second radial surface of the seal. In some embodiments, the interface of the seal and seat is a keyed interface. In some embodiments, the non-circular geometry comprises one of the following: rectangle, rounded rectangle, semi-circle, ellipse, triangle, trapezoid, parallelogram, a circle save for at least one straight line edge, spline, or keyway. In some embodiments, the seat comprises at least one ridge or groove extending in a direction parallel to the axis when the base is engaged to the reservoir, and the seat is adapted to engage with a complementary groove or ridge in the base. In some embodiments, the reservoir comprises a projection or a recess adjacent the seat and radially spaced from the axis when the base is engaged to the reservoir, and the reservoir is adapted to engage with a complementary recess or projection of the feeding teat. In some embodiments, the projection and recess are configured to engage using a keyed interface. In some embodiments, the seat comprises a screw thread extending helically within the opening and adapted to engage with a complementary screw thread of the seal.

In another aspect, a method of feeding an animal is provided. The method comprises providing a reservoir for storing a liquid for oral consumption by the animal and having a peripheral seat defined at an opening to the reservoir. The method comprises providing an elongate artificial feeding teat having a base defining a peripheral seal at a distal end thereof. An interface of the feeding teat and reservoir is configured to prevent clockwise and anticlockwise rotation of the feeding teat about a longitudinal axis of the feeding teat when the base is engaged to the reservoir. The method comprises engaging the seal with the seat to allow sealed ducting of the liquid from the reservoir through the opening to the feeding teat for oral consumption by the animal. The peripheral seal comprises a peripheral surface of the seal which engages with a corresponding peripheral surface of the seat. The peripheral surface of the seal and the seat each comprise a complementary non-circular geometry having one or two lines of symmetry in a cross-sectional plane to which the axis is normal.

In some embodiments, the method comprises engaging the seal with the seat to secure the base within the reservoir at a predetermined rotational position about the axis. In some embodiments, the feeding teat comprises a nipple at a distal end opposite the first distal end, the nipple having a closeable slit extending in a direction parallel to a plane passing through the axis, and the predetermined rotational position corresponds with vertical alignment of the slit. In some embodiments, the base defines a base axis along which the base is translated to engage with the opening of the reservoir, and the longitudinal axis of the shaft extends in a plane passing through the base axis. The plane is angled between 0 and 90 degrees from the base axis. In some embodiments, the method comprises engaging the seal with the seat to secure the base within the reservoir such that the predetermined rotational position corresponds with downward orientation of the shaft.

In another aspect, a system is provided for feeding an animal. The system comprises a liquid reservoir for containing a liquid for feeding the animal and an artificial feeding teat for ducting the liquid from the reservoir to the animal for oral consumption of the liquid by the animal.

In another aspect, an artificial feeding teat is provided for ducting a liquid from a liquid reservoir to an animal for oral consumption of the liquid by the animal. The artificial feeding teat comprises a shaft with an elongate straight axis. The shaft is hollow to define a duct for the liquid to flow through. A base is located at a first distal end of the shaft and defines an inlet opening to the duct. A nipple of an elastomeric material is located at a second distal end opposite the first distal end. The nipple has a nipple wall to define a closure to the duct at the second distal end of the shaft, save for at least one closeable opening comprising a slit through the nipple wall. The closeable opening is deformable between a natural state where the nipple wall at the slit compressively seals the closeable opening and a deformed state that creates an opening through the nipple wall via which liquid can pass from the duct to the animal. The slit is located at a region of the nipple wall that will become more compressed when pressure inside the duct is increased to enhance the compressive sealing of the closeable opening. When seen in a cross-sectional plane with which the elongate straight axis is coextensive, the region of the nipple wall at which the slit is located comprises a concave exterior surface profile that extends substantially parallel to the elongate straight axis.

In some embodiments, when seen in the cross-sectional plane with which the elongate axis is coextensive, the region of the nipple wall at which the slit is located includes no convex exterior surface profile. In some embodiments, when seen in a cross-sectional plane with which the elongate axis is coextensive, the region of the nipple wall at which the slit is located comprises only a concave exterior surface profile. In some embodiments, when seen in a cross-sectional plane with which the elongate axis is coextensive, the region of the nipple wall at which the slit is located comprises only a concave and smooth or continuous exterior surface profile. In some embodiments, the concave exterior surface profile is configured to change profile to be less concave when pressure inside the duct is increased. In some embodiments, the slit extends in a direction parallel to the elongate axis. In some embodiments, the slit is of a length that is less than a height of the nipple in a direction of the elongate axis.

In some embodiments, in a cross-sectional plane to which the elongate axis is normal, the shaft is of a circular exterior shape. In some embodiments, in the cross-sectional plane to which the elongate axis is normal, the shaft is of the circular exterior shape and of a constant cross section along its length. In some embodiments, the shaft is of a cylindrical exterior shape. In some embodiments, in the cross-sectional plane to which the elongate axis is normal, the shaft is of the circular exterior shape and of a tapering cross section along its length toward the second distal end. In some embodiments, the duct is circular in cross section. In some embodiments, the shaft is of a consistent wall thickness section along at least part of its length.

In some embodiments, in a cross-sectional plane to which the elongate axis is normal, the nipple is of a circular exterior shape. In some embodiments, the nipple tapers to a point or dome at its distal end opposite to the shaft. In some embodiments, a rate of tapering of the nipple reduces along the elongate axis toward the distal end of the nipple opposite to the shaft. In some embodiments, the nipple wall is of a consistent wall thickness. In some embodiments, the concave exterior surface profile is a surface of revolution about the elongate axis. In some embodiments, the artificial feeding teat is formed as a unitary item of an elastomeric material.

In some embodiments, the artificial feeding teat has a stiffening ring between the second distal end of the shaft and the nipple. The stiffening ring has a wall thickness that is greater than the nipple wall adjacent the stiffening ring and greater than a shaft wall adjacent the stiffening ring. In some embodiments, the stiffening ring extends radially into the duct. In some embodiments, when seen in a cross-sectional plane with which the elongate axis is coextensive, the duct comprises a first tapering portion which tapers from a central portion toward the first distal end. In some embodiments, a thickened wall portion associated with the first tapering portion increases in thickness toward the first distal end. In some embodiments, the duct comprises a second tapering portion which tapers from the central portion toward the second distal end. In some embodiments, the region of the nipple wall at which the slit is located comprises a truncated concave cone.

In another aspect, an elastomeric nipple of or for an artificial feeding teat is provided. The artificial feeding teat has a base for connecting to a source of liquid from which a ducted flow of liquid can flow to the elastomeric nipple. The elastomeric nipple comprises a nipple wall configured to define a closure to the ducted flow save for at least one closeable opening comprising a slit through the nipple wall. The closeable opening is deformable between a natural state where the nipple wall at the slit compressively seals the closeable opening and a deformed state that creates an opening through the nipple wall via which liquid can pass from the ducted flow to an animal. The slit is located at a region of the nipple wall that will become more compressed when pressure in the ducted flow is increased to enhance the compressive sealing of the closeable opening. The nipple wall has a concave exterior surface profile that extends parallel to an elongate axis of the artificial feeding teat.

In another aspect, an artificial feeding teat is provided for ducting a liquid from a spout of a liquid reservoir to an animal for oral consumption of the liquid by the animal. The artificial feeding teat comprises a shaft with an elongate axis, the shaft being hollow to define a duct for the liquid to flow through. A base is located at a first distal end of the shaft and defines an inlet opening to the duct. The base is formed as one piece with the shaft and is configured to be pushed onto the spout of the liquid reservoir to form a snap-fit engagement with the spout. A nipple is located at a second distal end of the shaft opposite the first distal end. The nipple has a nipple wall defining a closure to the duct at the second distal end save for at least one closeable opening through the nipple wall. A knurled exterior region is formed as one piece with the base. The knurled exterior region comprises a plurality of peripheral ribs disposed about the base and configured to provide manual grip for pushing the base onto the spout.

In some embodiments, the plurality of peripheral ribs extend along the base in a direction from the first distal end toward the second distal end. In some embodiments, the plurality of peripheral ribs are circumferentially spaced about the base. In some embodiments, the base defines an internal spout-receiving cavity configured to receive at least a portion of the spout when the base is pushed onto the spout. In some embodiments, the base comprises an internal retaining formation configured to engage a complementary retaining formation of the spout to form the snap-fit engagement. In some embodiments, the plurality of peripheral ribs are configured to resist slippage of a user's fingers relative to the base while the base is pushed onto the spout.

In some embodiments, the artificial feeding teat is a one-piece elastomeric teat body comprising the base, the shaft, the nipple, and the knurled exterior region. In some embodiments, the base is free of a screw thread configured to threadingly engage the spout. In some embodiments, the snap-fit engagement is formed by axial movement of the base onto the spout without requiring rotation of the base relative to the spout. In some embodiments, the knurled exterior region is configured to increase manual traction during axial push-on installation of the artificial feeding teat on the spout.

In some embodiments, an artificial feeding teat comprises shaft wall having a wall thickness that increases toward the base of the artificial feeding teat. The wall may define at least part of the duct, an internal spout-receiving cavity, or a transition between the duct and the internal spout-receiving cavity. In some embodiments, the wall thickness increases toward the base by a tapering internal surface of the shaft while an exterior surface of the artificial feeding teat remains substantially continuous. In some embodiments, the wall thickness increases progressively, stepwise, or continuously toward the base along at least part of the shaft.

In some embodiments, the increased wall thickness near the base provides greater resistance to deformation, chewing, biting, or other animal-induced damage near the base while maintaining a more flexible portion nearer the nipple. In some embodiments, the increased wall thickness near the base encourages an animal to position its mouth further forward on the artificial feeding teat during feeding. In some embodiments, the increasing milk chamber wall thickness is used with a non-round base configured to control rotational orientation of the artificial feeding teat, with a nipple having a concave exterior surface profile configured to enhance sealing of a slit, with a knurled exterior region of a base configured to facilitate push-on snap-fit engagement with a spout, or with another artificial feeding teat configuration.

In some embodiments the present invention may be said to be a reservoir for feeding an animal, the reservoir comprising:
a reservoir body configured to store a liquid for oral consumption by the animal; and
a seat defined at an opening of the reservoir body and configured to releasably engage a peripheral seal of a base of an elongate artificial feeding teat to provide sealed fluid communication from the reservoir body through the opening and into the elongate artificial feeding teat;
wherein the seat comprises a peripheral surface having a non-circular geometry in a cross-sectional plane perpendicular to a longitudinal axis of the elongate artificial feeding teat when the base is engaged with the seat, the non-circular geometry having one or two lines of symmetry and being configured to mate with a complementary non-circular geometry of a corresponding peripheral surface of the peripheral seal to prevent clockwise and anticlockwise rotation of the elongate artificial feeding teat about the longitudinal axis; and
wherein the non-circular geometry of the seat is configured to secure the elongate artificial feeding teat at a predetermined rotational position about the longitudinal axis when the base is engaged with the seat.

In some embodiments the present invention may be said to be a method of feeding an animal, the method comprising:
providing a reservoir storing a liquid for oral consumption by the animal, the reservoir having a seat defined at an opening of the reservoir;
providing an elongate artificial feeding teat having a base defining a peripheral seal at a distal end of the elongate artificial feeding teat, the peripheral seal and the seat having complementary non-circular geometries each having one or two lines of symmetry in a cross-sectional plane perpendicular to a longitudinal axis of the elongate artificial feeding teat when the base is engaged with the seat; and
engaging the peripheral seal with the seat to provide sealed fluid communication from the reservoir through the opening and into the elongate artificial feeding teat while the complementary non-circular geometries prevent clockwise and anticlockwise rotation of the elongate artificial feeding teat about the longitudinal axis and secure the elongate artificial feeding teat at a predetermined rotational position about the longitudinal axis.

In some embodiments the present invention may be said to be a system for feeding an animal, the system comprising:
a liquid reservoir configured to contain a liquid for feeding the animal, the liquid reservoir comprising a seat defined at an opening of the liquid reservoir; and
an artificial feeding teat configured to duct the liquid from the liquid reservoir to the animal for oral consumption of the liquid by the animal, the artificial feeding teat comprising a shaft defining a duct, a nipple at a distal end of the shaft, and a base defining a peripheral seal configured to releasably engage the seat;
wherein the peripheral seal and the seat comprise corresponding peripheral surfaces having complementary non-circular geometries in a cross-sectional plane perpendicular to a longitudinal axis of the artificial feeding teat when the base is engaged with the seat; and
wherein the complementary non-circular geometries are configured to prevent clockwise and anticlockwise rotation of the artificial feeding teat about the longitudinal axis and to secure the artificial feeding teat at a predetermined rotational position about the longitudinal axis when the base is engaged with the seat.

In some embodiments the present invention may be said to be an artificial feeding teat for ducting a liquid from a liquid reservoir to an animal for oral consumption of the liquid by the animal, the artificial feeding teat comprising:
a shaft having an elongate straight axis, the shaft being hollow to define a duct for the liquid to flow through;
a base located at a first distal end of the shaft and defining an inlet opening to the duct; and
a nipple of an elastomeric material located at a second distal end of the shaft opposite the first distal end, the nipple having a nipple wall defining a closure to the duct at the second distal end, apart from a closeable opening comprising a slit through the nipple wall, the closeable opening being deformable between a natural state in which the nipple wall at the slit compressively seals the closeable opening and a deformed state in which the closeable opening permits liquid to pass from the duct to the animal;
wherein the slit is located in a region of the nipple wall that becomes more compressed when pressure inside the duct is increased to enhance compressive sealing of the closeable opening; and
wherein, when viewed in a cross-sectional plane with which the elongate straight axis is coextensive, the region of the nipple wall in which the slit is located comprises a concave exterior surface profile extending substantially parallel to the elongate straight axis.

In some embodiments the present invention may be said to be an elastomeric nipple for an artificial feeding teat having a base connectable to a source of liquid from which a ducted flow of liquid can flow to the elastomeric nipple, the elastomeric nipple comprising:
a nipple wall configured to define a closure to the ducted flow, apart from a closeable opening comprising a slit through the nipple wall, the closeable opening being deformable between a natural state in which the nipple wall at the slit compressively seals the closeable opening and a deformed state in which the closeable opening permits liquid to pass from the ducted flow to an animal;
wherein the slit is located in a region of the nipple wall that becomes more compressed when pressure in the ducted flow is increased to enhance compressive sealing of the closeable opening; and
wherein the nipple wall has a concave exterior surface profile extending parallel to an elongate axis of the artificial feeding teat.

In some embodiments the present invention may be said to be an artificial feeding teat for ducting a liquid from a spout of a liquid reservoir to an animal for oral consumption of the liquid by the animal, the artificial feeding teat comprising:
a shaft having an elongate axis, the shaft being hollow to define a duct for the liquid to flow through;
a base located at a first distal end of the shaft and defining an inlet opening to the duct, the base being formed as one piece with the shaft and configured to be pushed onto the spout of the liquid reservoir to form a snap-fit engagement with the spout;
a nipple located at a second distal end of the shaft opposite the first distal end, the nipple having a nipple wall defining a closure to the duct at the second distal end, apart from at least one closeable opening through the nipple wall; and
a knurled exterior region formed as one piece with the base, the knurled exterior region comprising a plurality of peripheral ribs disposed about the base and configured to provide manual grip for pushing the base onto the spout.

In some embodiments the present invention may be said to be an artificial feeding teat for ducting a liquid from a liquid reservoir to an animal for oral consumption of the liquid by the animal, the artificial feeding teat comprising:
a shaft having an elongate axis, the shaft defining a milk chamber through which the liquid flows;
a base located at a first distal end of the shaft and configured to connect the artificial feeding teat to the liquid reservoir; and
a nipple located at a second distal end of the shaft opposite the first distal end, the nipple having a nipple wall defining a closure to the milk chamber, apart from at least one closeable opening through the nipple wall;
wherein the milk chamber is defined at least in part by a milk chamber wall having a wall thickness that increases toward the base so that a region of the artificial feeding teat nearer the base has greater resistance to animal-induced damage than a region of the artificial feeding teat nearer the nipple.

### BRIEF DESCRIPTION OF THE DRAWINGS

FIG. 1 is a top view of an artificial feeding teat.

FIG. 2 is a side view of the artificial feeding teat of FIG. 1.

FIG. 3 is an end view of the artificial feeding teat of FIG. 1.

FIG. 4 is a sectional view through the artificial feeding teat of FIG. 1.

FIG. 5 is a sectional view through the artificial feeding teat of FIG. 1.

FIG. 6 is a sectional view through section BB as shown in FIG. 5.

FIG. 7 is a sectional view through section AA of FIG. 5.

FIG. 8 is a perspective view of the artificial feeding teat of FIG. 1.

FIG. 9 is a close-up view of region C of FIG. 8.

FIG. 10 shows an artificial feeding teat according to another example.

FIG. 11 is an end view of the artificial feeding teat of FIG. 10.

FIG. 12 is a cut-away perspective view of the artificial feeding teat of FIG. 10.

FIG. 13 is a sectional view through a part of the artificial feeding teat of FIG. 10.

FIG. 14 is an end view of the artificial feeding teat of FIG. 1.

FIG. 15 is a perspective view of a feeder.

FIG. 16 is a sectional view through the feeder of FIG. 15.

FIG. 17 is a sectional view showing the artificial feeding teat of FIG. 1 engaged with the feeder of FIG. 15.

FIG. 18 is a side view of an artificial feeding teat according to another example.

FIG. 19 is an end view of the artificial feeding teat of FIG. 18.

FIG. 20 is another end view of the artificial feeding teat of FIG. 18.

FIG. 21 is a perspective view of a feeder according to another example.

FIG. 22 is a sectional view showing the artificial feeding teat of FIG. 18 engaged with the feeder of FIG. 21.

FIG. 23 is a side view of an artificial feeding teat according to another example.

FIG. 24 is an end view of the artificial feeding teat of FIG. 23.

FIG. 25 is another end view of the artificial feeding teat of FIG. 23.

FIG. 26 is a perspective view of a feeder according to another example.

FIG. 27 is a sectional view showing the artificial feeding teat of FIG. 23 engaged with the feeder of FIG. 26.

FIG. 28 is a rear perspective view showing an artificial feeding teat according to another example.

FIG. 29 is a perspective view of a feeder according to another example.

FIG. 30 is a sectional view of the feeder of FIG. 29.

FIG. 31 is a side view of the artificial feeding teat of FIG. 28 engaged with the feeder of FIG. 29.

FIG. 32 is a side view of an artificial feeding teat according to another example.

FIG. 33 is a rear view of the artificial feeding teat of FIG. 32.

FIG. 34 is a front view of the artificial feeding teat of FIG. 32.

FIG. 35 is a perspective view of a reservoir according to another example.

FIG. 36 is a side view of the artificial feeding teat of FIG. 32 engaged with the reservoir of FIG. 35.

FIG. 37 is a sectional side view of a feeder according to another example.

FIG. 38 is a sectional side view of an artificial feeding teat according to another example engaged with the feeder of FIG. 37.

FIG. 39 is a perspective view of a feeder according to another example.

FIG. 40 is a perspective view of an artificial feeding teat according to another example.

FIG. 41 is a sectional side view of a portion of the feeder of FIG. 39.

FIG. 42 is a sectional view showing the artificial feeding teat of FIG. 40 engaged with the feeder of FIG. 39.

FIG. 43 is a sectional front view of the artificial feeding teat of FIG. 40.

FIG. 44 is a perspective view of a feeder according to another example.

FIG. 45 is a perspective view of an artificial feeding teat according to another example.

FIG. 46 is a sectional view showing the artificial feeding teat of FIG. 45 engaged with the feeder of FIG. 44.

FIG. 47 is a perspective view of a feeder according to another example.

FIG. 48 is a perspective view of an artificial feeding teat according to another example.

FIG. 49 is a sectional view of a variation of an artificial feeding teat including a stiffening ring and a duct having a sectional interior surface profile.

FIG. 50 is a perspective view of an artificial feeding teat having a base with a knurled exterior region.

FIG. 51 is a side view of the artificial feeding teat of FIG. 50.

FIG. 52 is a top-down view of the artificial feeding teat of FIG. 50.

FIG. 53 is a bottom-up view of the artificial feeding teat of FIG. 50.

FIG. 54 is an end view of the artificial feeding teat of FIG. 50, viewed from a base end of the artificial feeding teat.

FIG. 55 is an end view of the artificial feeding teat of FIG. 50, viewed from a nipple end of the artificial feeding teat.

FIG. 56 is a perspective cross-sectional view of the artificial feeding teat of FIG. 50, showing a duct extending through a shaft and a base configured to receive a spout of a liquid reservoir.

FIG. 57 is a side cross-sectional view of the artificial feeding teat of FIG. 50, showing a duct extending through a shaft and a base configured to receive a spout of a liquid reservoir.

FIG. 58 is a cross-sectional view of a liquid reservoir having a spout configured to be received by the base of the artificial feeding teat of FIG. 50.

FIG. 59 is a perspective view of an artificial feeding teat having a base with a knurled exterior region.

FIG. 60 is a side view of the artificial feeding teat of FIG. 59.

FIG. 61 is a top-down view of the artificial feeding teat of FIG. 59.

FIG. 62 is a bottom-up view of the artificial feeding teat of FIG. 59.

FIG. 63 is an end view of the artificial feeding teat of FIG. 59, viewed from a base end of the artificial feeding teat.

FIG. 64 is an end view of the artificial feeding teat of FIG. 59, viewed from a nipple end of the artificial feeding teat.

### DETAILED DESCRIPTION.

With reference to the accompanying drawings there is shown an artificial feeding teat 1. In a preferred form the feeding teat 1 is made as a unitary item. In some examples the teat may be made from more than one part wherein the parts are assembled or constructed together. In a preferred form the artificial feeding teat is at least in part and preferably entirely made from an elastomeric material such as a rubber material. In some examples the material may be selected from a range of nonsynthetic, synthetic or semisynthetic polymerization products, generally consisting of a hydrocarbon-based polymer. The teat or parts of it may also be made from thermoplastic or a thermoset rubber or a silicone rubber.

The use of a preferred material will make the teat resiliently flexible. Deformation forces that the teat is subjected to will result in the teat returning to its natural state after the deformation forces are removed.

As seen in the figures, the artificial feeding teat 1 comprises of a hollow shaft 2 that has an elongate axis XX. The elongate axis XX is preferably straight. In a preferred form the feeding teat is fully symmetric about the elongate axis XX.

The teat is preferably made by injection moulding. The mould preferably has a part line that passes through the axis XX. This may create a part line in the finished teat that lies on a plane parallel to and passing through the axis XX.

The hollow shaft has a shaft wall 56 that is located about a duct 3 that is defined by the hollow shaft 2. The duct 3 allows for a liquid to flow through the hollow shaft. In a preferred form, a liquid that may be or contain milk is able to flow into the duct from a reservoir such as a bottle or container with which the feeding teat 1 is able to engage through an inlet opening 9.

In a preferred form the feeding teat is able to engage with the reservoir in a releasable manner. The feeding teat preferably comprises of a base 6 that is located at a first distal end 7 of the hollow shaft 2. The base 6 defines an inlet opening 9 to the duct for liquid to flow through and into the duct. The base is preferably adapted and configured for being able to releasably secure to the reservoir. In the example shown in the accompanying drawings, the base has a male threaded profile to allow the base to threadingly engage with a complimentary female threaded profile of the reservoir.

In one form of the teat there may be a one way valve 50 located at the inlet opening. This valve can allow milk into the duct 3 and helps prevent milk in the duct from flowing out of the inlet opening.

The feeding teat also includes a nipple 10 that is located at a second distal end 11 opposite the first distal end. The nipple 10 has a nipple wall 13 that defines a closure to the duct at the second distal end 11 of the shaft.

The nipple wall 13 includes at least one slit 14 through the nipple wall 13. The slit 14 allows for an outlet opening to be created to the duct where liquid in the duct 3 can pass from the duct 3 through the slit 14 to the animal. In some forms of the teat there may be just one slit. In some forms there may be two slits. In some forms there may be 3 or 4 slits. Where there are a plurality of slits they are each preferably equispaced and located about the elongate axis XX.

The, or each slit, is preferably a straight slit. The, or each, slit 14 is located at a region of the nipple wall that presents radially outwardly. This helps ensure the flow of liquid through the opening at the slit will not jet purely axially and has component of flow direction out of the teat that is radial. The slit is preferably straight and it lies in a plane that is parallel to within which the elongate axis XX lies. Furthermore, or alternatively, the slit preferably lies in a plane along a substantially vertical direction. A vertically oriented slit is more prone to opening under compression load from an animal feeding on the teat. The jaw and/or tongue and/or teeth of an animal is generally positioned above and below the teat during feeding resulting in compression along a vertical direction. A horizontally slit may be less prone to opening and instead may be constricted and reduce flow of liquid. Furthermore, a vertically oriented slit reduces spillage of milk from an animal's mouth when feeding. This reduces milk wastage and the ingestion of air during feeding, and also reduces the cleaning required about the floor below the feeding teat. A horizontal slit is more liable to increase spillage of milk from an animal's mouth when feeding.

The slit may be of a length that is at least 20% of the length in the XX direction of the nipple. The slit may be of a length that is at least 50% of the length in the XX direction of the nipple. The slit may be of a length that is at least 75% of the length in the XX direction of the nipple.

In one example of use of the teat a reservoir is a container that is located above the teat outlet opening and hence applies a positive pressure head to the liquid in the teat. In another example where the animal is to be bottle fed, the reservoir may for example be a flexible bottle. Such allow for a person to squeeze the bottle to thereby increase the pressure inside the duct 3 of the feeding teat 1. The duct 3 may be full of the liquid or may also include a gas such as air. A squeezing of the bottle to which the feeding teat is connected, will increase the pressure inside the duct 3. The slit is located at a region of the nipple that will become more compressed when pressure in the duct 3 is increased. By being located at a region of the nipple wall 13 that will compress when the pressure inside the duct is increased, will result in the facing surfaces 16 and 17 of the wall at the slit to press together. This will enhance the seal between the facing surfaces 16 and 17 of the wall 13 at the slit 14 and will reduce the prospect of liquid passing through the slit due to the enhanced seal. Further examples of nipple-end slit sealing arrangements are described later in this specification

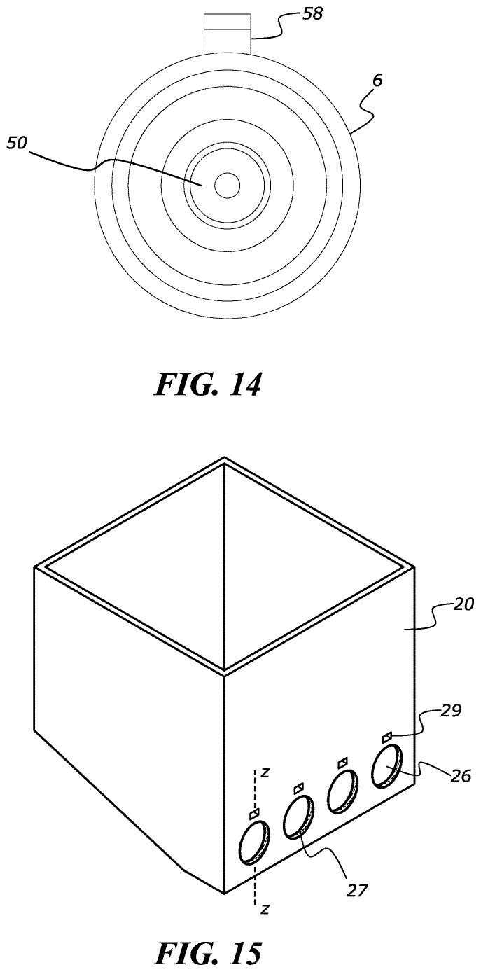

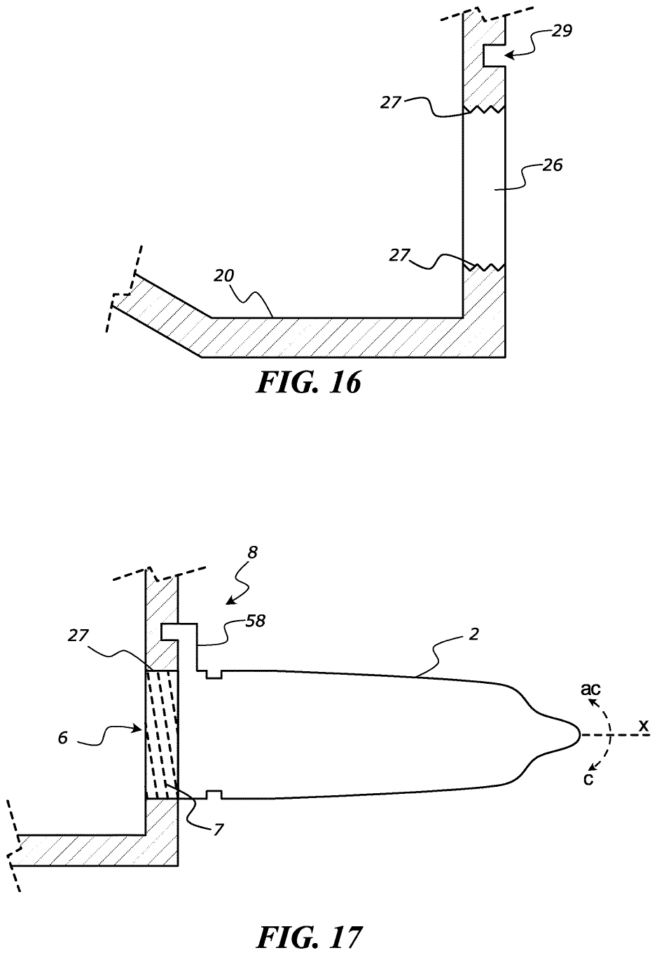

Referring again to FIGS. 3 and 4, and also to FIGS. 14-17, the base 6 of the teat 1 defines a peripheral seal 8 that is configured to releasably engage with a seat 27 defined at an opening 26 to a reservoir 20 to allow a sealed ducting of the liquid from the reservoir 20 through the opening 9 into the duct 3. In this example, a male thread is helically arranged on the periphery of the base 6 and is threadingly engageable with a female thread helically arranged about the inner surface of the opening 26. One or both of these threads may include a rubberised surface to enhance sealing and/or one or both of the opening and the base may include a seal ring about the opening or base to seal when in contact with the other part. Various other mechanisms for implementing the seal and seat to allow sealed ducting are possible, including those described in more detail below.

In alternative examples, it may be preferable that the periphery of the base is threadingly engageable with a female thread on the inner surface of the opening 26, but where said corresponding threads are parallel threads rather than helical. Such a configuration would provide a push-fit configuration for engaging the base of the teat with the opening to provide a seal, as opposed to a rotational engagement of a helical thread. Furthermore, such parallel threads may be arranged to be on a peripheral seal of the base that is non-round to prevent rotation of the teat. Non-round bases of the teat will be discussed in more detail further below.

The interface of the teat 1 and reservoir 20 is configured to prevent clockwise C or anticlockwise AC rotation of the teat 1 about the longitudinal axis XX when the base 6 is engaged to the reservoir 20. In this example, a projection 58 is radially spaced from the longitudinal axis XX and when the base 6 is fully screwed into the opening 26 the projection engages with a recess 29 to secure the teat rotationally to the reservoir 20. The projection may be “L” shaped and extend from a peripheral region of the base. The projection 58 may be of a pliable but resilient material such as a plastics material to allow for some bending of the projection when screwing the base 6 into the opening 26 of the reservoir whilst allowing the projection to spring back into the recess 29 when the projection 58 and recess 29 are aligned. In an alternative example, the seat may include a projection and the seal may include a complimentary recess. Various other mechanisms for implementing the seal and seat to prevent clockwise and anticlockwise rotation are possible, including those described in more detail below.

Preventing rotation of the teat when engaged in the reservoir reduces wear on the seal 8 and seat 27 improving the sealed ducting and thereby enhancing the robustness and lifetime of the teat and reservoir. This facility also prevents the teat from becoming disconnected from the reservoir due to rough use by an animal, which would result in significant spillage of the liquid from the reservoir. In some examples, where a particular alignment of the teat and reservoir is desired, the seal and seat may be configured to secure the base 6 at a predetermined rotational position about the axis XX when the base is engaged to the reservoir. In this example, the projection 58 is positioned above the teat when engaged with the reservoir, and this may be helpful in some situations where certain features of the teat require a particular alignment. For example, in examples where the closable orifice 14 in the nipple 10 is a straight slit, it may be desirable to align this vertically to reduce spillage of the liquid from an animal's mouth, and/or result in easier opening of the slit to dispense liquid as discussed above.

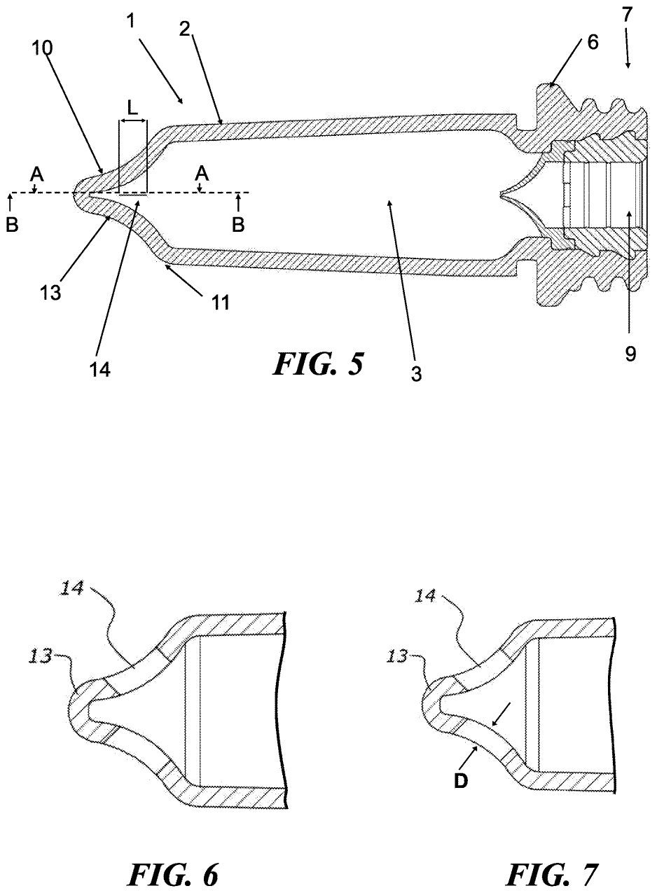

In the example illustrated in FIGS. 2-7, the slits 14 extend radially along an axis YY normal to the longitudinal axis XX. The slits may also extend longitudinally. In the example illustrated in FIG. 15, a vertical axis ZZ is shown extending through one of the openings 26 of the reservoir 20. The projection 58 extends along the YY axis of the teat and the recess 29 is located along the ZZ axis of the reservoir. When the projection 58 is located within the recess 29 this ensures that the YY axis is aligned with the ZZ axis such that the slits 14 are vertically aligned.

The reservoir 20 may be a flexible bottle with a single opening 26, a large drum with multiple openings 26 as shown in FIG. 15 for engaging with multiple teats 1. In other examples the reservoir may be in the form of a feeding bar comprising a laterally extending hollow member with spaced apart openings and a central conduit to a liquid reservoir for receiving, storing and delivering the liquid.

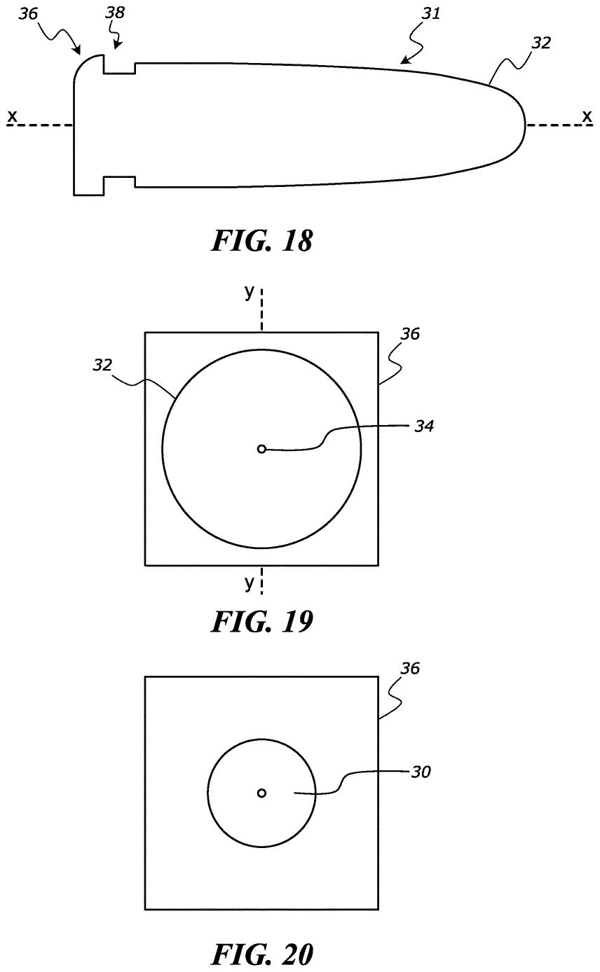

FIG. 18-22 illustrate a teat 31 and reservoir 40 according to another example. Many features of the teat will be similar to those already described with differences as noted in the following. The teat 31 of this example has a nipple 32 with a more rounded profile and with a circular closeable opening 34. In this example, the teat 31 is a push-in or pull-through teat in which the base 36 does not have a thread but has at least a portion with larger cross-sectional dimensions than an opening 46 in the reservoir 40 so that when the teat is pulled through the opening 46 the base 36 is secured against the inside wall of the reservoir 40. The teat may be released from the reservoir by reversing this movement and pulling the base back inside the reservoir.

The teat 31 may alternatively or additionally be used in a push-through manner in which the lower edge of the base right-angled corner in FIG. 18 is inserted inside the opening 32 and then the upper edge of the base rounded cornier in the figure is rotated in through the opening 32. As the material of the base is compliant, the base will deform to allow this manipulation until the reduced circumference region proximate the shaft is reached when the base material will then reform to have larger sectional dimensions that the opening and thereby be retained and sealed within the reservoir.

The base 36 defines a peripheral seal 38 which may include a flexible and/or resilient surface feature such as a rubberised surface or a sealing ring to help ensure a sealed ducting of liquid from the reservoir through a duct opening 30 in the base into a duct of the teat. A seat 47 is defined at the opening 46 of the reservoir and may include a flexible and/or resilient surface feature such as a rubberised surface or a sealing ring to help ensure a sealed ducting of liquid from the reservoir through the opening. These additional sealing features of the seat 47 may be provided at the interior surface of the opening 46 and/or on the interior wall of the reservoir about the opening 46 in order to contact with the seal 38. Similarly, additional sealing features of the seal 38 may be provided along a longitudinally extending peripheral surface of the base 36 and/or along a laterally extending surface of the base in order to contact with the seat 37.

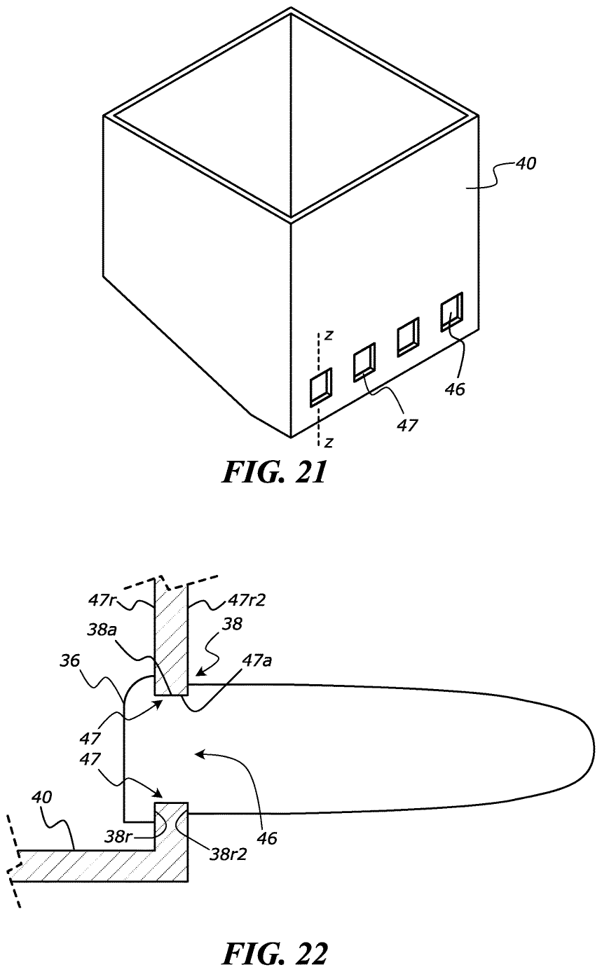

In some examples, as shown FIG. 22, the peripheral seal 38 of the teat presents a longitudinal sealing surface 38a extending substantially parallel to a longitudinal axis of the teat and parametrically around the teat. The longitudinal surface 38a of the peripheral seal 38 comprises a non-circular geometry in a cross-sectional plane to which the axis is normal and is adapted to engage with a corresponding longitudinal surface 47a of the seat 47. The non-circular geometry may have one or two lines of symmetry in order to limit the rotational positions in which the base of the teat can be engaged with the reservoir. This may be employed to ensure that a slit in the nipple is aligned vertically. Examples of such non-circular geometries with one or two lines of symmetry include: rectangles, rounded rectangles, ellipses, triangles.

In some examples, as also shown in FIG. 22, the peripheral seal 38 may also comprise a radial sealing surface 38r extending radially from an end of the longitudinal surface 38a, and which is adapted to engage with a corresponding radial surface 47r of the seat. The radial surface 38r may be provided at either end of the longitudinal surface 38a, for example depending on whether the teat has a push-through or pull-through configuration. The combination of the above described longitudinal surface 38a and the radial surface 38r provides improved sealing and reduces leakage of milk about the interface of the teat and reservoir.

In some examples, as also shown in FIG. 22, the peripheral seal 38 may also comprise a second radial surface 38r2 extending radially from the other end of the longitudinal surface 38a, and which is adapted to engage with a corresponding second radial surface 47r2 of the seat 47. The multiple radial sealing surfaces are positioned either side of the longitudinal sealing surface along the axial direction of the teat. This presents a groove which can then receive wall of the reservoir, and seal against the wall to prevent leakage. Accordingly, it is preferable that the dimensions of, or between, said radial sealing surfaces and axial sealing surface are configured to provide an interference fit or similar arrangement to ensure a tight seal once engaged. Furthermore, it is preferable that the radial sealing surface(s) are substantially normal to the axial direction of the teat, however in some examples they may be inclined or tapered away from said normal arrangement. This may be combined with a wall of the reservoir or seat having a complimentary tapering to ensure a tight fit once engaged.

Such an arrangement of having a longitudinal sealing surface and one or more radial sealing surfaces provides discrete sealing surfaces that seal independently from the other, such that there is not a single surface and/or plane in which liquid may leak if the peripheral seal partially fails, such as due to wear or debris.

The interface of the teat 31 and reservoir 40 is configured to prevent clockwise and anticlockwise rotation of the teat about its longitudinal axis XX. In this example this is achieved using the interface of the seal 38 and seat 37 in which an longitudinal surface 38a of the peripheral surface of the seal engages with a corresponding longitudinal surface 47a of the peripheral surface of the seat. Rotation is prevented by employing a non-circular geometry of the peripheral surface of the seal 38 in a cross-sectional plane to which the axis XX is normal. The illustrated geometry is square, however other non-circular shapes could alternatively be used such as an oblong rectangle, a semi-circle, an ellipse, a triangle, a trapezoid, a parallelogram, a polygon, or a circle save for one or more straight line edges or radial protrusions. In some examples, the non-circular geometry comprises zero, one or two lines of symmetry and/or orders of rotational symmetry. These shapes may be employed to restrict the number of rotational orientations of the teat when engaged in the reservoir to one or two—this may be used to ensure that the or each slit is vertically aligned The peripheral surface of the seat 47 has a complementary shape, in this example a square, such that when the base is engaged with the reservoir, rotational movement about the longitudinal axis XX of the teat is prevented.

In a preferable example, the peripheral surface of the seal 38 and the seat 47 has either zero lines of symmetry resulting only one possible rotational orientation when engaged, or one line of symmetry resulting in two opposing possible rotational orientations, in order to ensure an optimal orientation of the slit 14 of the teat, such as along a vertical plane as previously discussed.

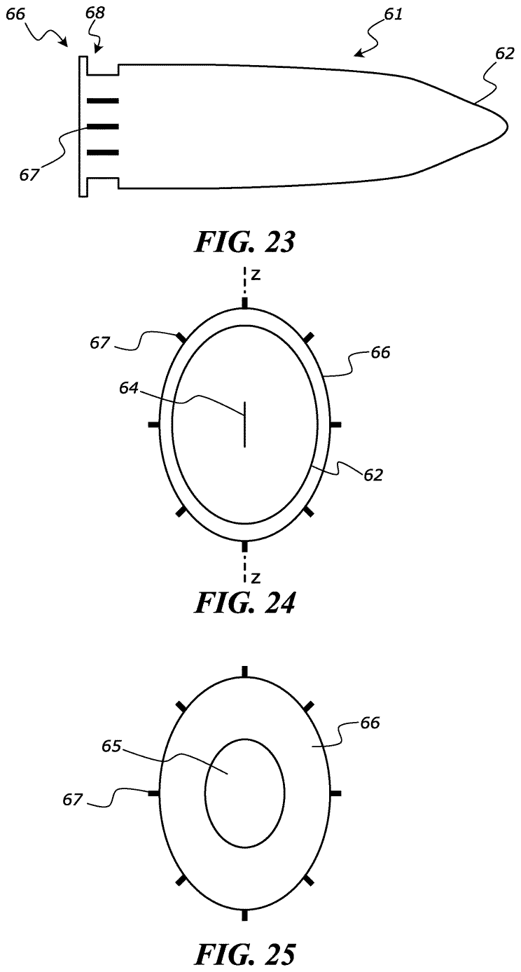

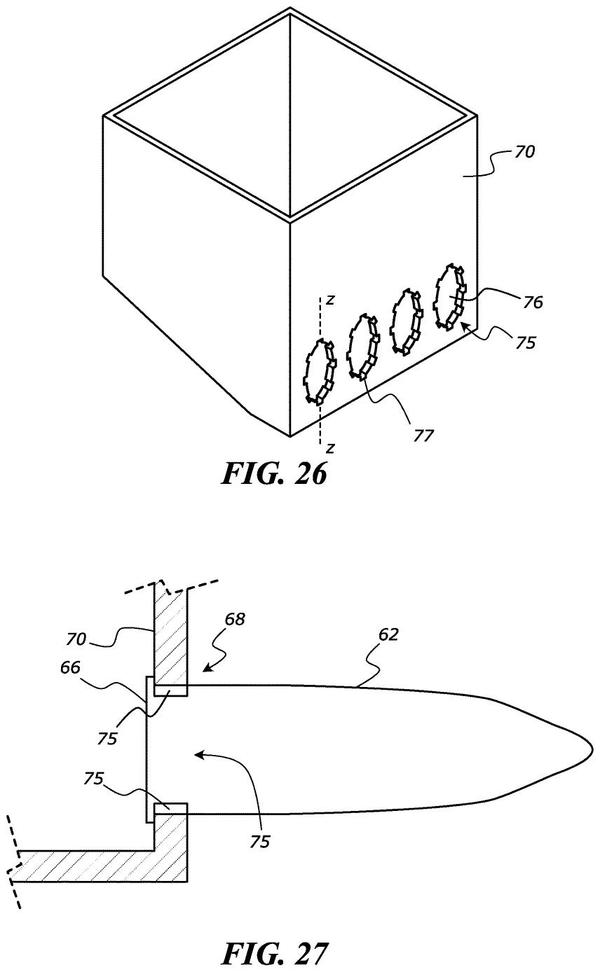

FIG. 23-27 illustrate a teat and reservoir according to another example. Many features of the teat will be similar to those already described with differences as noted in the following. The teat 61 of this example has a nipple 62 with a conical profile and with a single straight slit 64 providing a closeable opening at a distal end of the teat 61. In this example, the teat 61 is a pull-through teat in which the base 66 does not have a thread but has longitudinally extending ridges 67 forming part of a peripheral seal 68 which interfaces with a seat 75 defined by an opening 76 in a reservoir 70 which includes longitudinally extending grooves 77 complementary to the ridges 66. The base also has at least a portion with larger cross-sectional dimensions than the opening 76 in the reservoir 70 so that when the teat is pulled through the opening the base is secured against the inside wall of the reservoir. The teat may be released from the reservoir by reversing this movement and pulling the base back inside the reservoir.

The peripheral seal 68 is defined by the base 66 and may include a flexible and/or resilient surface feature such as a rubberised surface or a sealing ring to help ensure a sealed ducting of liquid from the reservoir through an opening 65 into a duct of the teat. The seat 75 defined by the opening 76 of the reservoir may include a flexible and/or resilient surface feature such as a rubberised surface or a sealing ring to help ensure a sealed ducting of liquid from the reservoir through the opening. These additional sealing features of the seat 75 may be provided at the interior surface of the opening 76 and/or on the interior wall of the reservoir 70 about the opening 76 in order to contact with the seal 68. Similarly, additional sealing features of the seal 68 may be provided along a longitudinally extending peripheral surface of the base 66 and/or along a laterally extending surface of the base in order to contact with the seat 75.

The interface of the teat 61 and reservoir 70 is configured to prevent clockwise and anticlockwise rotation of the teat about its longitudinal axis XX. In this example this is achieved using two different approaches, which may be used together or as alternatives. A first approach to preventing rotational movement is the use of the longitudinal ridges 67 of the seal 68 on the teat 61 being engaged within corresponding grooves 77 of the seat 75 on the reservoir 70. Once the teat 61 is engaged to the reservoir the ridges 67 are rotationally secured within the grooves 77 preventing rotational movement of the teat about the reservoir. The recesses and grooves may be in the form of a spline fitting. This approach may be used with the other teat examples as well as a base and reservoir opening having a circular sectional shape.

In a second approach, a non-circular geometry of the peripheral surface of the seal 68 is employed in a cross-sectional plane to which the axis XX is normal. The illustrated geometry is elliptical or oval although other non-circular shapes comprising zero or one line of symmetry may alternatively be used, for example non-square rectangles, non-isosceles triangles, a half-circle or a non-symmetrical keyed shape. The peripheral surface of the seat 75 has a complementary shape, in this example an ellipse or oval, such that when the base 66 is engaged with the 70 reservoir, rotational movement about the longitudinal axis XX of the teat is prevented.

The use of a non-circular shape having only one line of symmetry ensures that the teat is aligned in one of two rotational positions about the longitudinal axis XX and which are 180 degrees apart. This can be used for example to ensure that the slit 64 is vertically aligned along axis ZZ when the teat is engaged to the reservoir. Having the slit vertically aligned reduces horizontal jetting of the liquid from the slit which tends to spill from an animal's mouth. Having the slit vertically oriented reduces spillage of liquid from the animal's mouth.

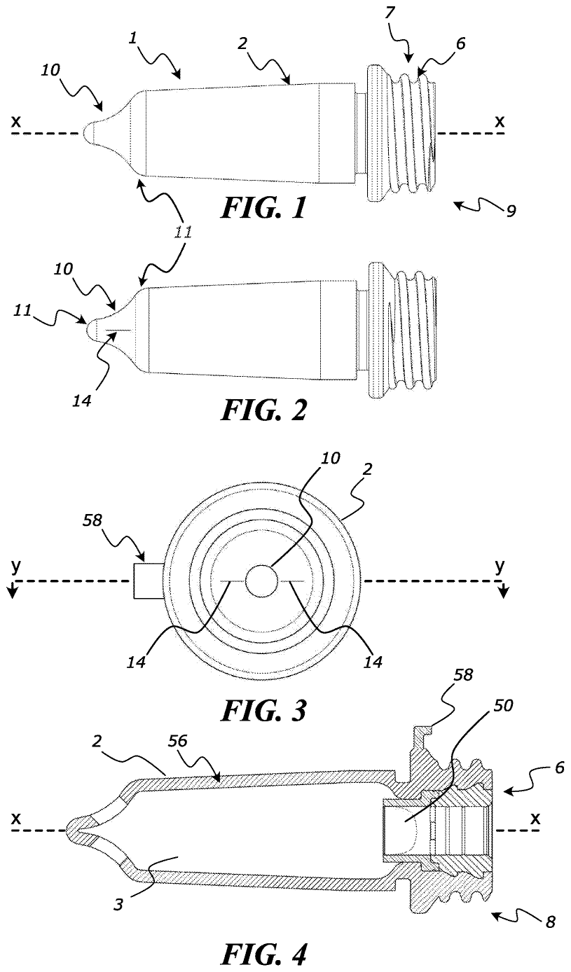

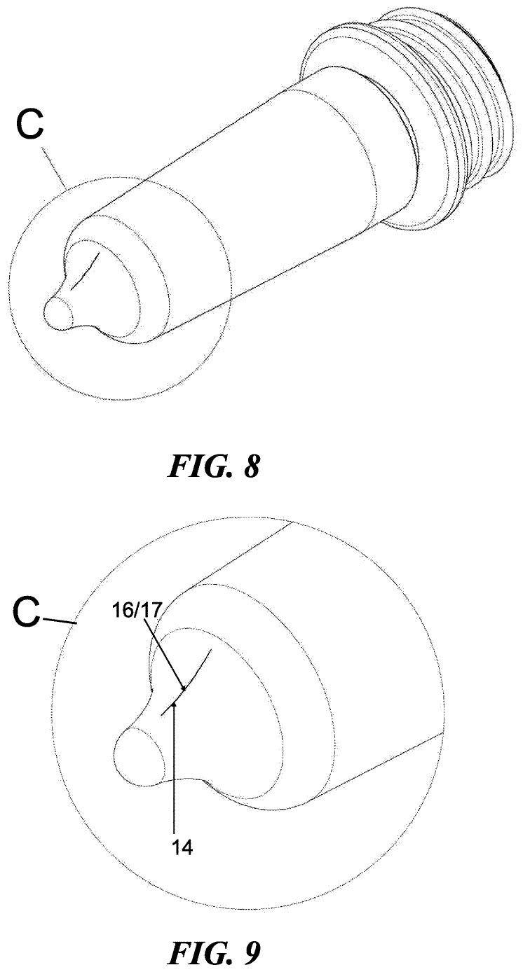

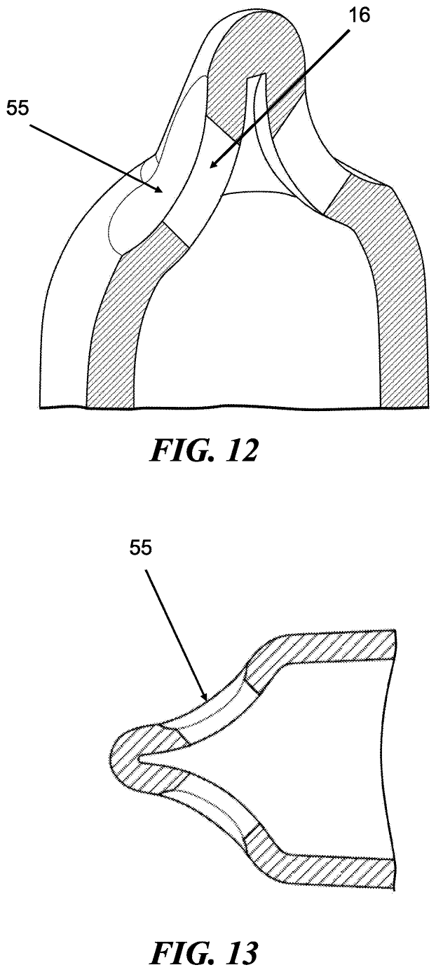

In this example, the slit 64 is at a distal end of the teat 61. In other examples similar to those of FIG. 1-13 where there are two slits which include a longitudinally extending component, the radial components of the slits are vertically aligned.

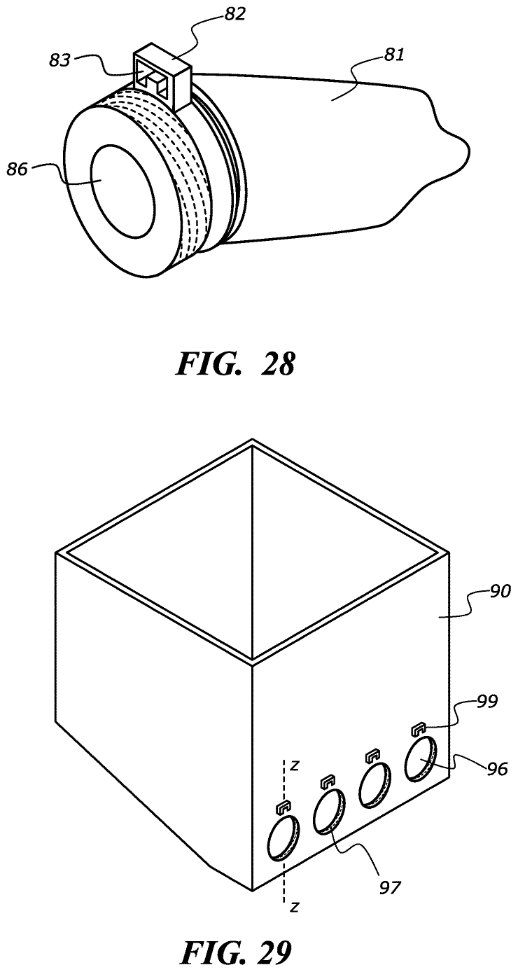

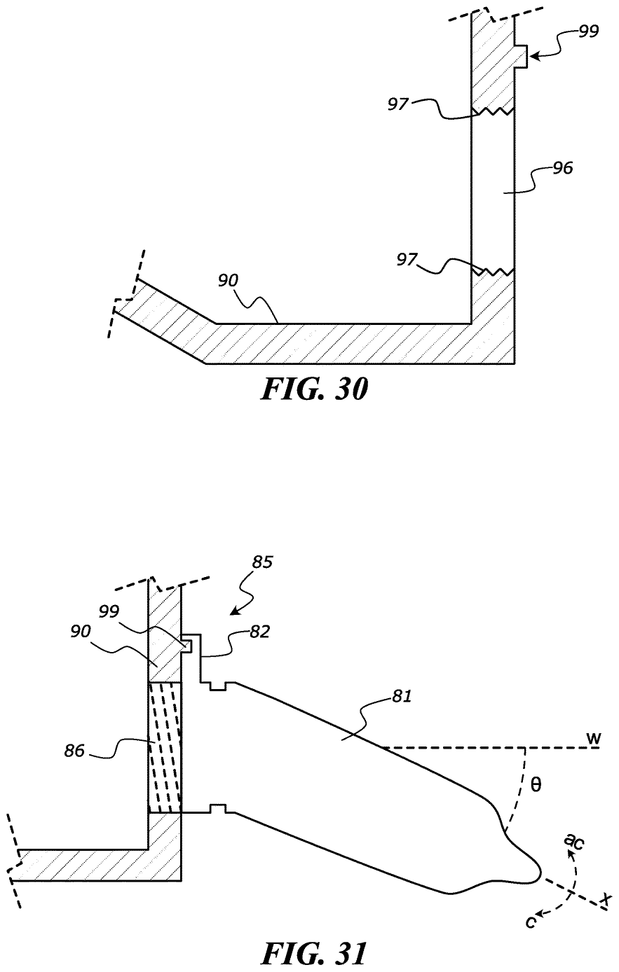

FIG. 28-31 illustrate a teat and reservoir according to another example. Many features of the teat will be similar to those already described with differences as noted in the following. The teat 81 of this example is threaded and includes a locking member 82 extending laterally from a periphery of the base 86, the locking member including a keyed recess 83. The reservoir 90 includes a threaded opening 96 and a keyed projection 99 which is complimentary to the keyed recess 83 of the base. The keyed recess 83 and keyed projection 99 form a keyed interface of the teat and reservoir when the teat is oriented in a predetermined rotational position.

The shaft of the teat extends at an angle to a base axis WW along which the base is translated or rotated to engaged with the opening of the reservoir. In this example, the angle θ between the base axis WW and the longitudinal axis of the shaft XX is approximately 20 degrees, but may extend between 0 and 90 degrees. The keyed interface provided by the recess 83 and projection 99 correspond to a single rotational position in which the shaft of the teat is sloping downwards, towards the ground. This may be useful for helping smaller animals to reach the teat. In some other examples, the shaft of the teat may slope upwards to assist with feeding taller animals, given a fixed height of the reservoir.

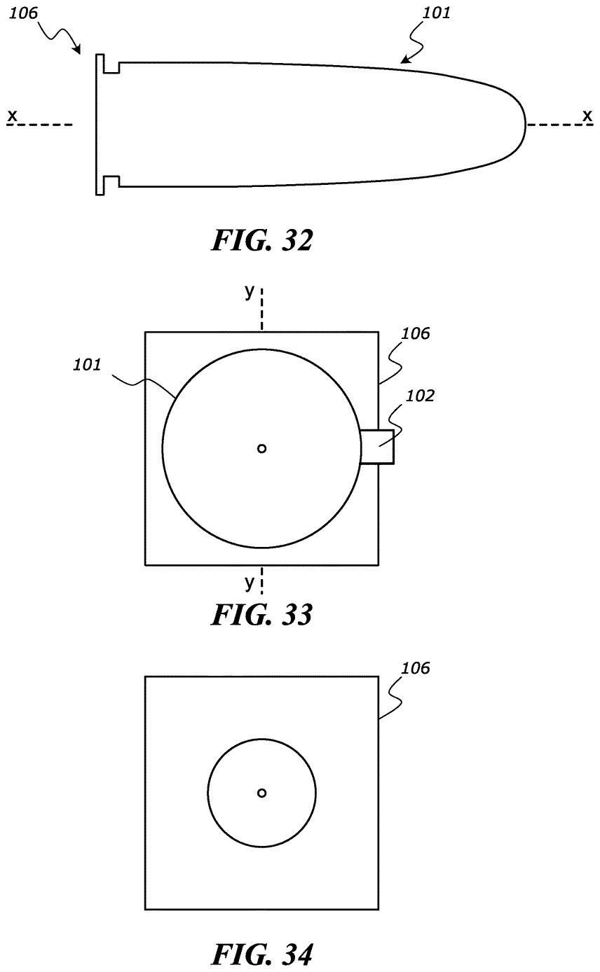

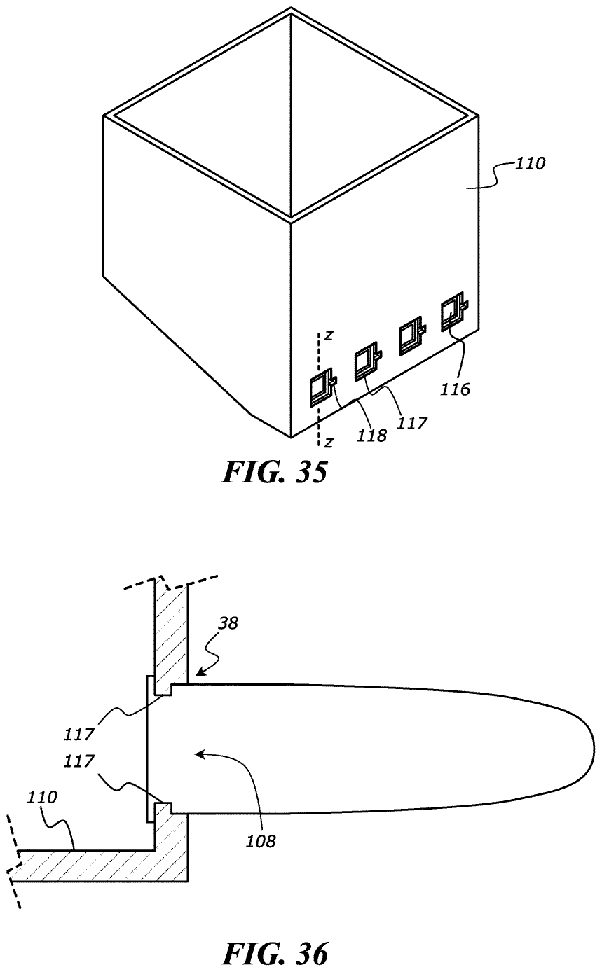

FIG. 32-36 illustrate a teat and reservoir according to another example. Many features of the teat will be similar to those already described with differences as noted in the following. The teat 101 of this example is push-through or pull-through teat which includes a keyed projection 102 extending lateral from the base 106. When engaged with the reservoir 110, the keyed projection interfaces with a keyed recess 118 in the external wall of the reservoir. This keyed interface provides for a single rotational position of the teat when engaged wit the reservoir. This is useful for preventing rotation of the teat within the reservoir, as well as aligning certain features of the teat in a desired manner, such as orienting a slit vertically and/or oriented an angled shaft downwardly or upwardly as previously described.

The base of the teat has a square cross-sectional shape which corresponds with a square sectional shaped orifice 116 which together with the keyed projection 102 and key recess 118 help to secure the teat in the desired rotational position. In this example, the opening 116 includes a square recessed region 117 which doesn't extend fully through to the interior of the reservoir 110. The base 106 has a corresponding profile where at 117 the cross-sectional width of the base narrows to allow that part of the base to pass fully through the opening 116 so that a resilient retaining wall of the base may be retained within the opening 116 by the peripheral seal of the teat interfacing with the seat 108 of the opening 116.

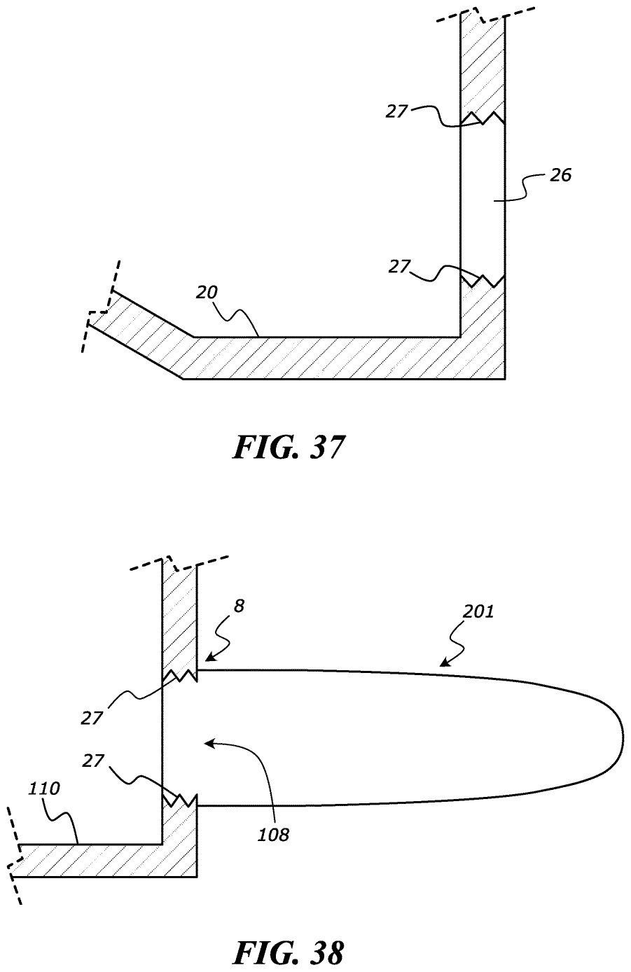

FIG. 37-38 illustrate a teat and a portion of a reservoir according to another example. Many features of the teat will be similar to those already described with differences as noted in the following. For instance, the reservoir is similar to that shown in FIG. 15, such that the reservoir has a circular opening 26 that defines a seat 27 in which the peripheral seal 8 of the teat 201 can sealingly engage. In this example, however, the seat 27 and peripheral seal 8 are each shown to threadingly engage to form a seal via corresponding parallel threads, rather than the helical threads as shown in FIGS. 15-17. This provides a connection in which the teat can be push-fit into the opening, rather than rotationally threaded. The parallel threads of the seat and peripheral seal each preferably are of a material type/hardness and/or size that provides sufficient ease of insertion/removal, and/or sealing performance, wherein said threads may be sized to have an interference fit along one or more dimensions. The peripheral seal of the teat is shown to be achieved by the parallel threads, however in other examples it may be preferable that such a teat further includes a flange to provide a sealing surface on the inside surface of the reservoir, such as shown in the teats of FIG. 22, 27 or 36 above, or FIG. 42 below. The parallel threads are shown as tapered threads, however a in alternative examples the threads may be rectilinear in profile.

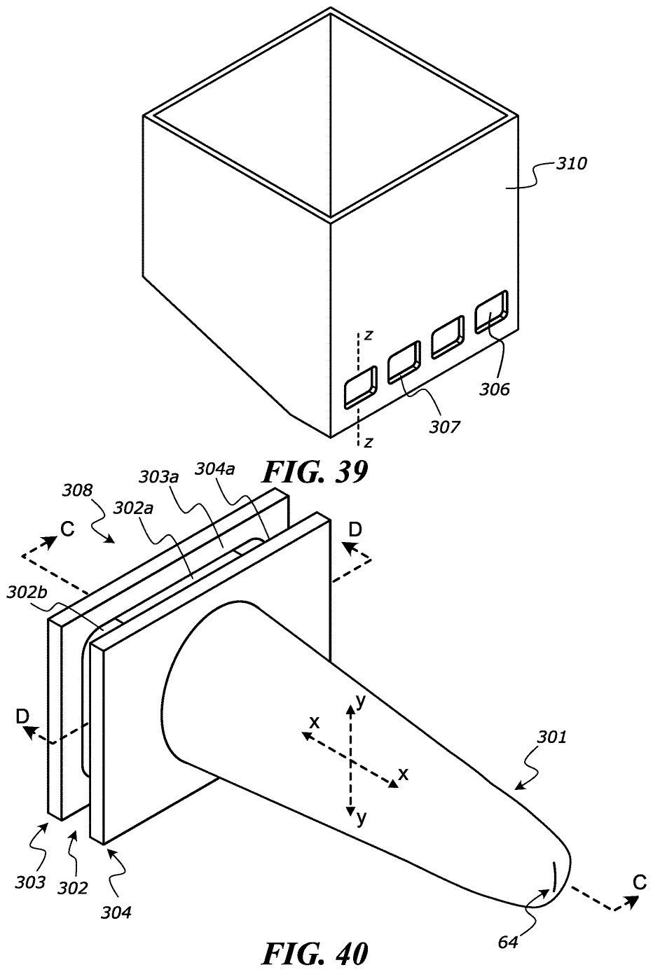

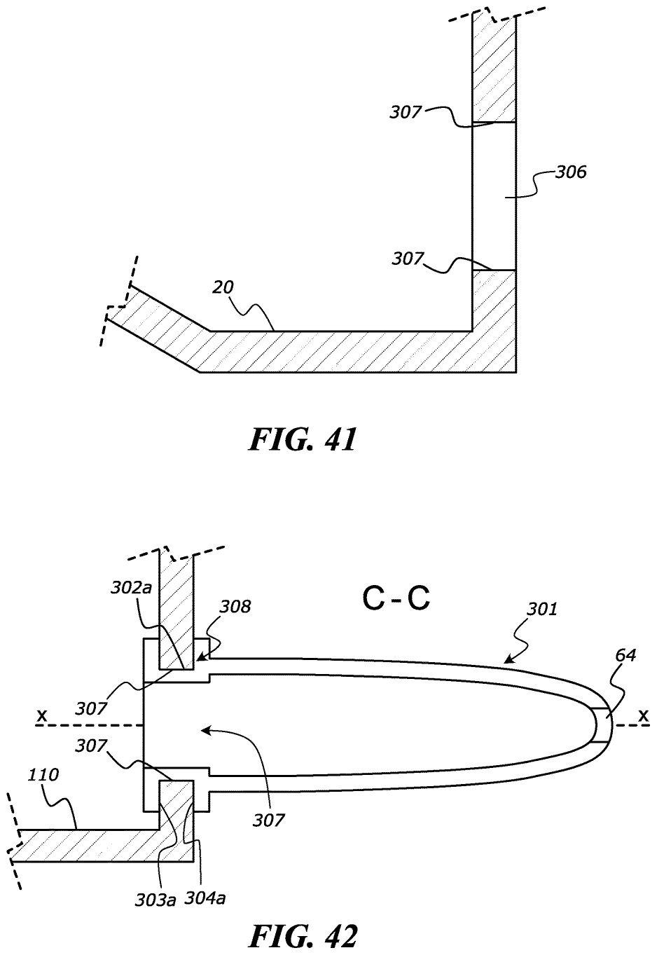

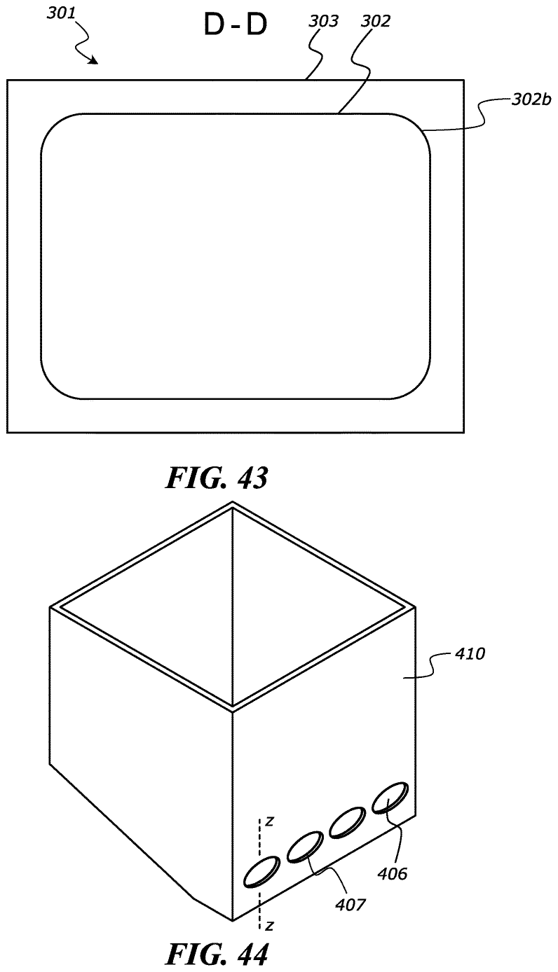

FIG. 39-43 illustrate a teat a reservoir according to another example. Many features of the teat will be similar to those already described with differences as noted in the following. The reservoir 310 includes oblong rectangular openings 306 in which a corresponding teat may sealingly engage with. The teat 301 has a shaped peripheral seal 308 which includes an oblong rectangular groove 302 that provides a sealing surface 302a extending parallel to an axial direction XX may be referred to as a “longitudinal seal” to seal, in a substantially radial direction outward from the x-axis, against the seat 307 of the opening 306. The peripheral seal further includes an inner flange 303 that provides a sealing surface 303a extending in a radial direction parallel to the YY axis and which may be referred to as an “radial seal” to seal, in a substantially axial direction along the x-axis toward the tip of the teat, against an inside surface of the reservoir near the opening. The peripheral seal further includes an outer flange 304 that provides a sealing surface 304a extending in a radial direction and may be referred to as a “second radial seal” to seal, in a substantially axial direction along the x-axis away from the tip of the teat, against an outside surface of the reservoir near the opening.

The teat 301 may engage with the opening in a push-through or pull-through manner. The oblong rectangular peripheral seal of the teat 301 ensures that the teat may only be engaged with the opening in one of two possible orientations, where both orientations are rotationally symmetrical by 180 degrees from the other. By orienting the slit 64 to be vertical relative to these positions, the oblong rectangular peripheral seal ensures that the slit 64 is in an intended orientation.

Preferably the dimension(s) of the sealing surface 302a are sized to provide an interference fit with the seat of the opening and/or the distance between the sealing surface 303a and sealing surface 304a is configured to provide an interference fit with the corresponding wall thickness of the reservoir. In some examples the longitudinal seal 302, when shaped non-round, may comprise polygonal corners, however it is preferable that the longitudinal seal 302, when shaped non-round, as illustrated, comprises corners 302b along its sealing surface that are filleted or rounded. This is preferable to help prevent small errors in fit between the seat of the opening and the peripheral surface that may otherwise result in functional failure of the radial seal that may affect adjacent seals such as the radial seal(s) and/or leakage.

In some alternative examples, one or both of the radial surfaces 303a, 304a may be omitted with the peripheral seal comprising only the longitudinal surface 302a.

Whilst the cross-sectional shape of the peripheral seal has been described as oblong rectangular, other shapes having one or two lines of symmetry may alternatively be used such as triangles, parallelograms or a semi-circle.

The sectional shape of the shaft of the teat may differ from the sectional shape of the peripheral seal, for example the shaft may be circular whilst the peripheral seal is rectangular.

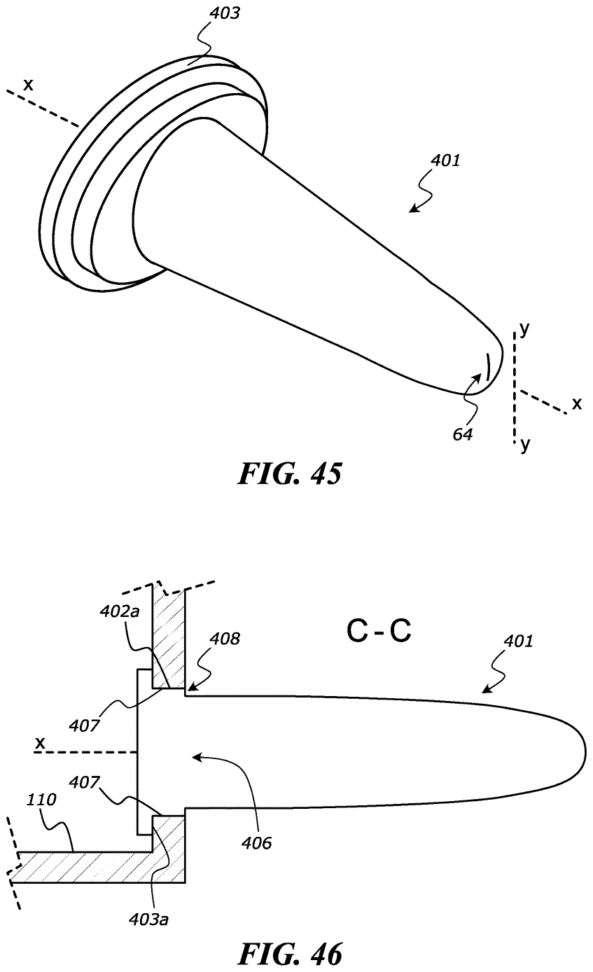

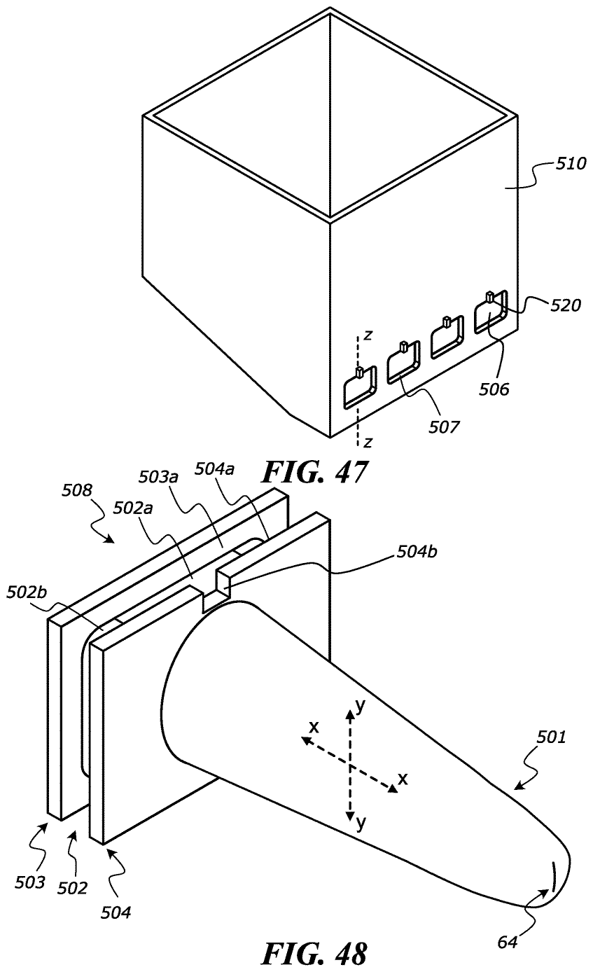

FIG. 44-46 illustrate a teat and a reservoir according to another example. Many features of the teat will be similar to those already described with differences as noted in the following. The reservoir 410 includes oval openings 406 that each present an oval seat 407. The teat 401 has a peripheral seal 408 that presents an oval sealing surface 402a “longitudinal seal” configured to sealingly engage with the seat 407, and an inner flange 403 “radial seal” with a sealing surface 403a configured to seal in an axial direction against an inner surface of the reservoir near the opening 406. The oval shape of the longitudinal seal, similar to the oblong rectangular seal of the teat 301, ensures that the teat may only be engaged with the opening in one of two possible orientations, where both orientations are rotationally symmetrical by 180 degrees from the other. The slit 64 is shown to be oriented relative to the radial seal accordingly to ensure its intended orientation

FIGS. 47 and 48 illustrate a teat a reservoir according to another example. Many features of the teat will be similar to those already described with differences as noted in the following. This example provides a variation on the example described with respect to FIG. 39-43. The reservoir 510 includes oblong rectangular openings 506 in which a corresponding teat may sealingly engage with. The teat 501 has a shaped peripheral seal 508 which includes an oblong rectangular groove 502 that provides a sealing surface 502a extending parallel to an axial direction XX may be referred to as a “longitudinal seal” to seal, in a substantially radial direction outward from the x-axis, against the seat 507 of the opening 506. The peripheral seal further includes an inner flange 503 that provides a sealing surface 303a extending in a radial direction parallel to the YY axis and which may be referred to as an “radial seal” to seal, in a substantially axial direction along the x-axis toward the tip of the teat, against an inside surface of the reservoir near the opening. The peripheral seal further includes an outer flange 504 that provides a sealing surface 504a extending in a radial direction and may be referred to as a “second radial seal” to seal, in a substantially axial direction along the x-axis away from the tip of the teat, against an outside.

The reservoir 510 additionally includes a lug or projection 520 adjacent the seat 507 and which projects forward of the wall of the reservoir and downwardly from the reservoir wall in the Z direction so that adjacent the opening 506 a part of the projection is slightly below the seat 507. The teat 501 includes a recess 504b which is correspondingly shaped to receive the part of the projection 520 below the seat 507. In this example the part of the projection and the recess have square sectional shapes however other shapes may alternatively be used. The recess may be in the outer flange 504, another part of the base of the teat or the shaft of the teat. In other alternatives, the projection may be provided on the other side of the reservoir wall adjacent the opening with the corresponding recess on the teat being in the inner flange 503 or another part of the base of the teat.

In alternative examples, the recess may be provided on the teat with a corresponding recess on the reservoir. The projection and recess provide further protection against rotation and robustness against wear and rough treatment of the teat by animals. The projection and recess also help to ensure that the teat is properly oriented in the reservoir, for example to ensure that the teat may be positions in only one or two rotational orientations. This may assist with vertically aligning a slit in the tip of the teat.

In some examples, a slit at the nipple end extends in a direction parallel to a plane passing through the axis. Where a second slit is employed, the second slit may extend in a second direction parallel to a second plane passing through the axis, and a component of the first and second directions perpendicular to the axis may be substantially colinear. The interface of the teat and reservoir may be configured to align a component of the or each slit perpendicular to the axis such that the component is coextensive with a predetermined radial of the axis when the base is engaged to the reservoir. The predetermined radial may correspond with a vertical alignment of the component of the or each slit perpendicular to the axis.

In some examples, a sectional shape having no lines of symmetry may be used so that the teat can engage with the reservoir in only one predetermined orientation. In an example the seal may include a key and the seat a corresponding keyway. This may be useful to ensure desired alignment of other asymmetric features, such as angling of the shaft from the base, for example to provide for a teat projecting downwardly from the reservoir whilst maintaining vertical alignment of one or more slits.

Various features described in one of the examples may be varied as described in the other examples. For example, the closeable openings may be readily exchanged between examples as may the ridge/groove arrangements, the threaded base and openings as well as the non-circular section shapes of the seals and seats.

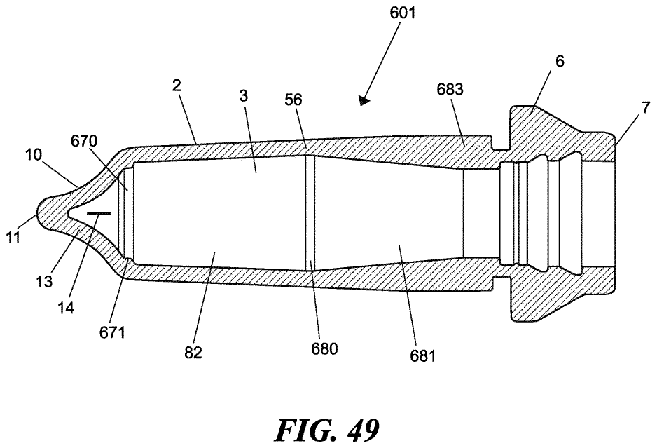

Further nipple-end features of an artificial feeding teat will now be described. These features may be used with any suitable base, including the base 6 or another base described above, or a variation thereof. The base configuration is not essential to the nipple-end features unless expressly required by a claim. Features in common with the artificial feeding teat 1 described above may use common reference numerals. But refence will now also be made to FIG. 49.

The nipple-end features described in this section may be used with the artificial feeding teat 1 or with another artificial feeding teat described herein. Features in common with previously described embodiments may use common reference numerals.

The feeding teat in FIG. 40 includes a nipple 10 that is located at a second distal end 11 opposite the first distal end. The nipple 10 has a nipple wall 13 that defines a closure to the duct at the second distal end 11 of the shaft.

The nipple wall 13 includes at least one slit 64 through the nipple wall 13. The slit 64 allows for a closeable opening or outlet opening to be created to the duct where liquid in the duct can pass from the duct through the slit 64 to the animal. The slit 64 may be a single straight slit at or adjacent a distal tip of the nipple 10. In other embodiments, the nipple may include another suitable closeable opening.

The or each slit is preferably a straight slit. The or each slit 14 is located at a region of the nipple wall that presents radially outwardly. This helps ensure the flow of liquid through the opening at the slit will not jet purely axially and has component of flow direction out of the teat that is radial. The slit is preferably straight and it lies in a plane that is parallel to within which the elongate axis XX lies. The slit may be of a length that is at least 20% of the length in the XX direction of the nipple. The slit may be of a length that is at least 50% of the length in the XX direction of the nipple. The slit may be of a length that is at least 75% of the length in the XX direction of the nipple.

When pressure inside the duct 3 increases, the region of the nipple wall 13 at which the slit 14 is located may become more compressed so that facing surfaces 16 and 17 of the nipple wall 13 at the slit 14 are urged toward one another. This may enhance sealing of the closeable opening and reduce leakage through the slit 14.

The region of the nipple wall 13 at where the slit 14 is located is of a concave exterior surface profile. The region of the nipple wall 13 at where the slit 14 is located is of a continuous or smooth concave exterior surface profile. In a preferred form the slit does not extend or cross into any region of the nipple and/or the duct that has a non-concave exterior surface profile. In a preferred form the slit does not extend or cross into any region of the nipple and/or the duct that has a sharp bend or corner surface profile.

In an example, the concave exterior and/or interior surface profile of the nipple wall extend longitudinally, substantially parallel to the elongate axis of the teat, when seen in a cross-sectional plane with which the elongate axis is co-extensive. The concave exterior surface profile extends from a first longitudinal position at the interface of the nipple and shaft and where the nipple has a largest diameter to a second more distal longitudinal position where the nipple has a smallest diameter. In other words, the concave exterior and/or interior surface may also reduce radially within this plane as it extends longitudinally. As the hydrostatic pressure inside the duct and nipple increases, the concave surface profile increases outward radial compression on the area of the nipple wall having the slits. This pushes the slit surfaces together, strengthening the seal between the opposing surfaces of the slits and thereby reducing leakage. The slits may be longitudinally oriented which further enhances this effect, although in alternative examples the slits may be oriented in other directions, for example circumferentially. When pressure inside the duct 3 is increased the exterior concave surface profile will become less concaved. It will be appreciated that as a result of this the material of the nipple wall 13 at this concave region will start to be subjected to compressive stress forces that as a result will force the two surfaces 16 and 17 of the nipple wall 13 at the slit 14 to compress together thereby improving sealing of the outlet opening when internal pressure in the duct increases.

In a preferred form the slit extends in a direction that is parallel to a plane that passes through the axis XX and in which plane the XX axis lies. Preferably there are two slits. Preferably the two slits are diametrically opposed and are of the same shape and size. The slit(s) preferably are not co-incident the injection moulded part line of the teat.

The nipple wall, at where the slit(s) is/are defined, is of a constant wall thickness. As a result, the depth of the slit D is of a constant depth along the slit length L.

As seen in the drawings the slit 14 is preferably of a length that is less than the height of the nipple when the height is taken in the direction XX. The slit has a first end that starts proximate the distal end of the nipple and extends to an opposite end that is more proximate the shaft.

The shaft of the feeding nipple is preferably of a cylindrical perimeter shape. In some configurations the shaft may taper, being wider at its first distal end proximate the base and narrower at the second distal end proximate the nipple. In a preferred form the shaft has a wall that is a constant thickness and hence the duct is preferably also of a circular cross section where the cross section is taken in at cross sectional plane to which the axis XX is normal to.

The nipple's external surface at a cross sectional plane to which the axis is normal is also circular at any given distance along the axis XX. More proximate the shaft, the nipple has a larger cross sectional perimeter shape than more proximate to the distal end of the nipple. As seen in the figures the cross sectional shape of the nipple when taken parallel to the axis XX, is preferably of a concave external shape. The concave external shape is preferably arcuate and the arc defines a surface of revolution of the axis XX. In other examples the curved outline of the exterior of the nipple, may be elliptical or parabolical or some other asymmetric generally concave form.

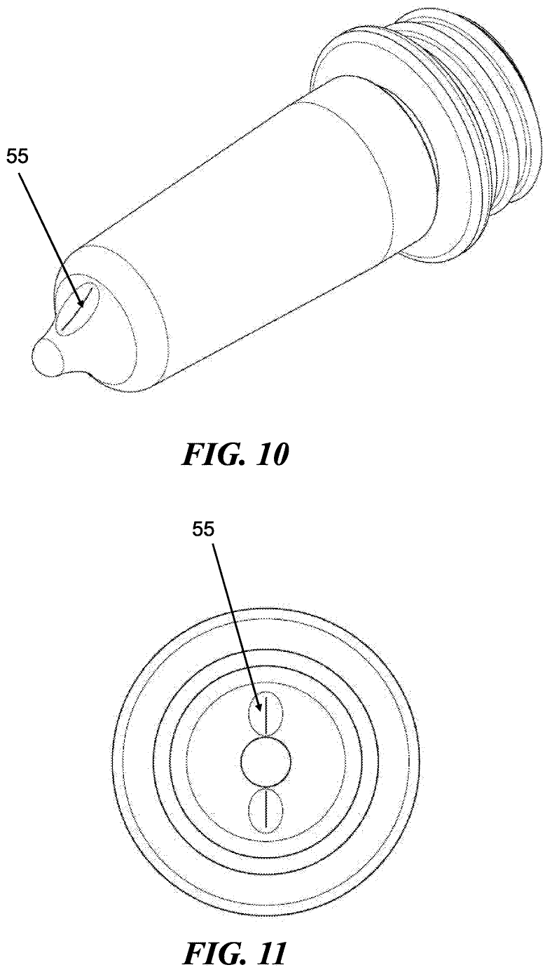

In FIGS. 10-13 there is shown a variation where the slit is located at a dimple 55 of the nipple wall. The dimple 55 comprises an area of reduced thickness of the nipple way and may be implemented by a depression or indent on the exterior and/or interior surface of the nipple wall. The rest of the nipple wall surrounding the nipple may have a concave or convex exterior shape. By being located at a dimple 55, the slit is still at a concave region of the nipple wall that will become less concave when there is an increase in internal pressure to help enhance the sealing effect of the nipple wall's two surfaces 16 and 17 at the slit. The dimple may be elongate with an elongate axis parallel to the elongate axis of the teat. The slit or slits may be elongate and has elongate axes parallel with the elongate axis of the teat.

The teat may comprise a stiffening ring or circumferential portion 670 between the nipple 10 and the shaft 2. The stiffening ring 670 comprises a thicker wall than the adjacent wall of the nipple or the adjacent wall of the shaft. In this example the thicker wall of the stiffening ring 670 extends radially inwards at 671 so that the exterior surface of the stiffening ring is continuous with the exterior surface of the shaft and nipple. However, in other examples, the exterior surface of the stiffening ring may extend radially outwards or both outwardly and inwardly compared with the adjacent shaft and nipple.

The stiffening ring 670 provides added rigidity at the shaft or duct transition to the nipple so that when milk pressure is increased within the duct, this pressure forces the nipple radially outwards more than the stiffening ring. Thus the pressure increase and the corresponding reactive deformation of the teat material is focussed on the nipple 10 so that the concave profile of the nipple walls become even less concave, thereby improving sealing performance of the slits 14, and hence further reducing milk leakage.

A further benefit of the stiffening ring 670 is to provide a slit propagation barrier. Aging of teats sometimes results in cracking of the elastomeric material of the nipple near the ends of the slits 14. This may be particularly prevalent where the slits are longitudinally aligned, so that cracking may extend from a base end of the slit back longitudinally towards the base. The addition of the stiffening ring with its thicker wall prevents cracking of the slit from extending beyond the stiffening ring, thereby reducing leakage as the teat ages.

The teat may additionally or alternatively comprise a duct with a sectional profile, for example as illustrated. The duct comprises a tapering portion 681 which tappers from a central portion 680 towards the base 6 of the teat. In other words, the diameter of this tapering portion 681 of the duct 3 is smaller at the base 6 than at the central portion 680. The central portion 680 may be positioned longitudinally substantially mid-way along the duct, although variations are contemplated. A second tapering portion 682 of the duct tappers from the central portion 680 towards the nipple 10. This arrangement provides a substantially convex interior surface profile for the duct 3.

By maintaining the external profile of the shaft 2, the thickness of the thickened wall portion 683 of the tapering portion 681 increases towards the base 6. This reduces the pliability or expandability of the shaft towards the base, meaning that pressure increases within the duct will lead to greater expansion of the teat where the wall is thinner. This means that less expansion of the duct/shaft near the base 6 results in more expansion at the nipple, further increasing outward radial compression on the nipple wall pushing the slit surfaces closer together. This effect further strengthens the seal between the opposing surfaces of the slits, further reducing leakage.

Alternative examples of the sectional profile may omit the central portion 680 or the second tapering portion 682. The wall thickness of the thickened wall portion 683 about the tapering portion 681 may remain substantially constant. In some examples the wall thickness of between the shaft and duct may remain substantially constant but thicker than the nipple wall.

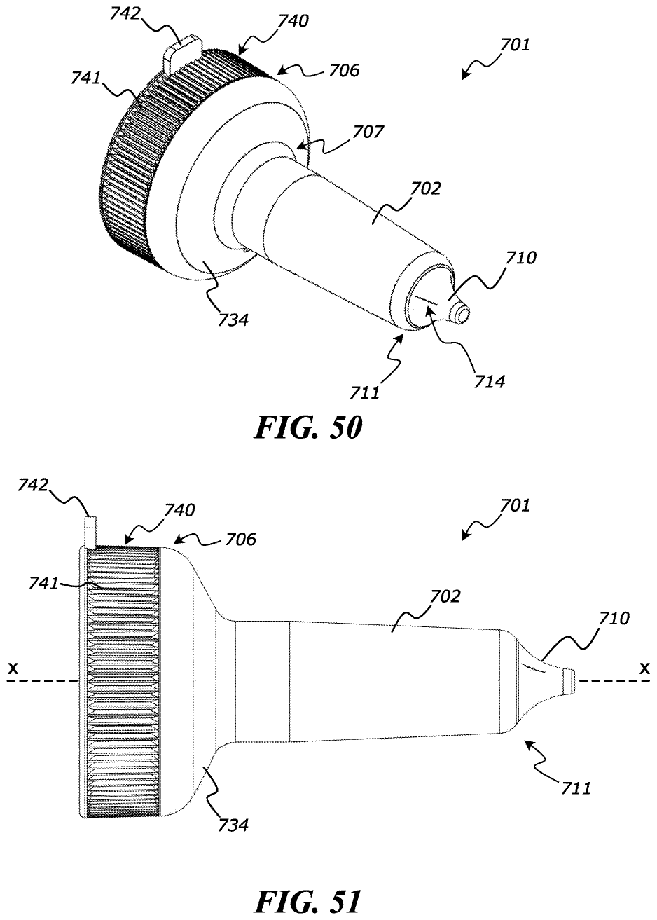

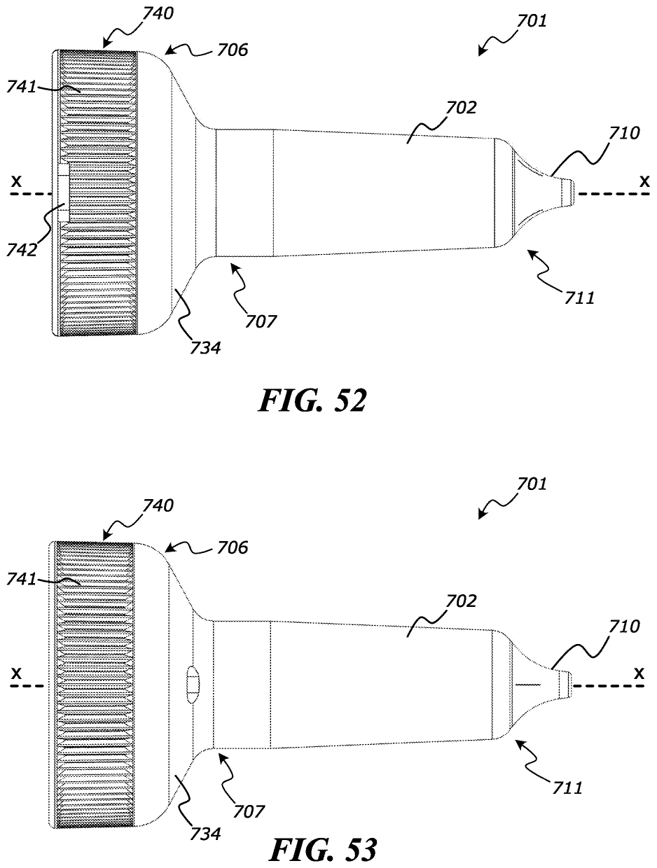

FIGS. 50 to 58 show an artificial feeding teat 701 according to another example. Many features of the artificial feeding teat 701 may be the same as, or similar to, features of the artificial feeding teats described above, and corresponding terminology is used for corresponding structures. The artificial feeding teat 701 is configured for ducting a liquid from a spout 727 of a liquid reservoir 720 to an animal for oral consumption of the liquid by the animal. The artificial feeding teat 701 comprises a shaft 702 with an elongate axis XX. The shaft 702 is hollow to define a duct 703 for the liquid to flow through. A base 706 is located at a first distal end 707 of the shaft 702 and defines an inlet opening 709 to the duct 703. A nipple 710 is located at a second distal end 711 of the shaft 702 opposite the first distal end 707. The nipple 710 has a nipple wall 713 defining a closure to the duct 703 at the second distal end 711 save for at least one closeable opening 714 through the nipple wall 713.

The base 706 is integrally formed with the shaft 702. In some embodiments, the base 706, the shaft 702, and the nipple 710 are formed as a single elastomeric teat body. The artificial feeding teat 701 may be molded from a resilient elastomeric material so that the base 706 can elastically deform during engagement with the spout 727 and can resiliently return toward an undeformed condition after engagement with the spout 727. The one-piece formation of the base 706 and the shaft 702 provides the artificial feeding teat 701 as a one-piece teat body.

The base 706 is configured to receive the spout 727 when the base 706 is pushed onto the spout 727. The base 706 defines an internal spout-receiving cavity 731 that receives at least a portion of the spout 727. The internal spout-receiving cavity 731 may be generally coaxial with the duct 703. In use, the base 706 can be moved axially relative to the spout 727 so that the spout 727 enters the internal spout-receiving cavity 731 through the inlet opening 709. The base 706 is configured to form a snap-fit engagement with the spout 727 by being pushed onto the spout 727 rather than being rotated onto the spout 727.

In some embodiments, the base 706 comprises an internal retaining formation 732 configured to engage a complementary retaining formation 728 of the spout 727 to form the snap-fit engagement. The internal retaining formation 732 may comprise an annular lip, bead, shoulder, groove, undercut, or other retaining profile formed on an internal surface of the base 706. The complementary retaining formation 728 of the spout 727 may comprise an annular bead, rib, shoulder, groove, undercut, or other retaining profile formed on an external surface of the spout 727. During installation, the base 706 may elastically expand as the internal retaining formation 732 passes over the complementary retaining formation 728. After the internal retaining formation 732 has passed the complementary retaining formation 728, the base 706 may resiliently contract so that the internal retaining formation 732 resists withdrawal of the base 706 from the spout 727.

The base 706 comprises a sealing portion 733 configured to seal against the spout 727. The sealing portion 733 may comprise an internal sealing surface of the base 706. In some embodiments, the sealing portion 733 is positioned axially between the inlet opening 709 and the shaft 702. In some embodiments, the sealing portion 733 is positioned adjacent the internal retaining formation 732. The sealing portion 733 may engage an external surface of the spout 727 with an interference fit. The elastomeric material of the base 706 may provide sealing pressure against the spout 727 so that liquid can pass from the liquid reservoir 720 through the spout 727, through the inlet opening 709, and into the duct 703 without substantial leakage at an interface between the base 706 and the spout 727.

The base 706 further comprises a knurled exterior region 740. The knurled exterior region 740 is formed integrally with the base 706 and comprises a plurality of peripheral ribs 741 disposed about the base 706. The peripheral ribs 741 are configured to provide manual grip for pushing the base 706 onto the spout 727. The peripheral ribs 741 may be formed in the same elastomeric material as the base 706 and may project outwardly from an exterior surface of the base 706. The peripheral ribs 741 may be circumferentially spaced about the base 706. In some embodiments, the peripheral ribs 741 extend along the base 706 in a direction from the first distal end 707 toward the second distal end 711. In some embodiments, the peripheral ribs 741 extend substantially parallel to the elongate axis XX. The ribs may extend at an incline instead. The ribs are preferably all parallel each other. Gaps where no ribs are provide, may exist between groups of ribs. In some embodiments, each peripheral rib 741 has a rib height in a radial direction and a rib length in an axial direction, the rib length being greater than the rib height. The ribs may present in a hatch pattern also.

The knurled exterior region 740 facilitates manual installation of the artificial feeding teat 701 on the spout 727. A user may grip the peripheral ribs 741 between the user's fingers and apply an axial pushing force to the base 706. The peripheral ribs 741 resist slippage of the user's fingers relative to the base 706 while the base 706 is pushed onto the spout 727. The peripheral ribs 741 are configured to assist the user in applying sufficient axial force to elastically deform the base 706 and move the internal retaining formation 732 into snap-fit engagement with the complementary retaining formation 728 of the spout 727.

The knurled exterior region 740 is provided on the one-piece elastomeric teat body itself. The peripheral ribs 741 can be used to push the base 706 directly onto the spout 727 without requiring a separate cap to be screwed onto the spout 727. In some embodiments, the base 706 is free of a screw thread configured to threadingly engage the spout 727. In some embodiments, the snap-fit engagement is achieved without requiring the base 706 to be rotated relative to the spout 727. In some embodiments, the peripheral ribs 741 are configured primarily to increase manual traction during axial push-on installation rather than to transmit screw-threading torque to a separate cap.

As shown in FIGS. 50 to 53, the knurled exterior region 740 may be located at or adjacent a rear end of the base 706, near the inlet opening 709. The shaft 702 may extend forwardly from the base 706 toward the nipple 710. The shaft 702 may taper from a wider portion adjacent the base 706 toward a narrower portion adjacent the nipple 710. The base 706 may have a larger outside diameter than the shaft 702 so that the base 706 provides an enlarged hand-engagement region. The peripheral ribs 741 may extend across at least a substantial portion of an axial length of the enlarged hand-engagement region.

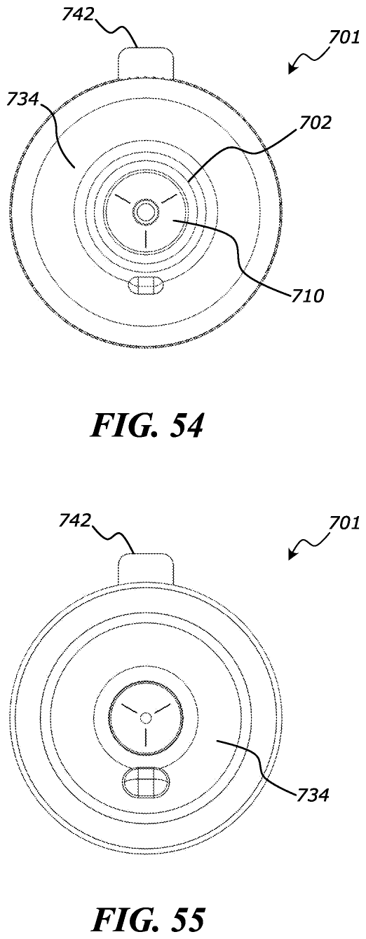

As shown in FIGS. 54 and 55, the base 706 may be generally circular when viewed along the elongate axis XX. The plurality of peripheral ribs 741 may be distributed around an outer circumference of the base 706. In some embodiments, the base 706 includes a tab 742 projecting radially from the base 706. The tab 742 may assist a user in locating, orienting, pulling, or manipulating the artificial feeding teat 701. The tab 742 may be formed as one piece with the base 706. In some embodiments, the tab 742 is positioned adjacent the knurled exterior region 740.

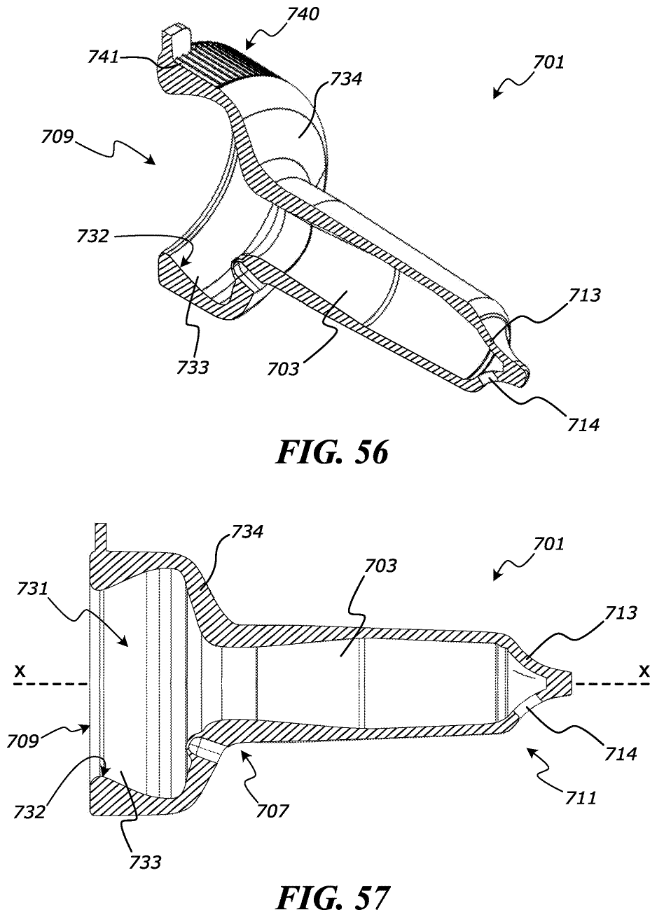

As shown in FIGS. 56 and 57, the duct 703 extends through the shaft 702 from the inlet opening 709 toward the nipple 710. The internal spout-receiving cavity 731 of the base 706 may have a larger diameter than at least part of the duct 703 so as to receive the spout 727. A transition portion 734 may extend between the internal spout-receiving cavity 731 and the duct 703. The transition portion 734 may guide liquid from the spout 727 into the duct 703. The base 706 may have a wall thickness selected to allow elastic expansion during snap-fit engagement while maintaining sufficient sealing force after the base 706 is engaged with the spout 727.

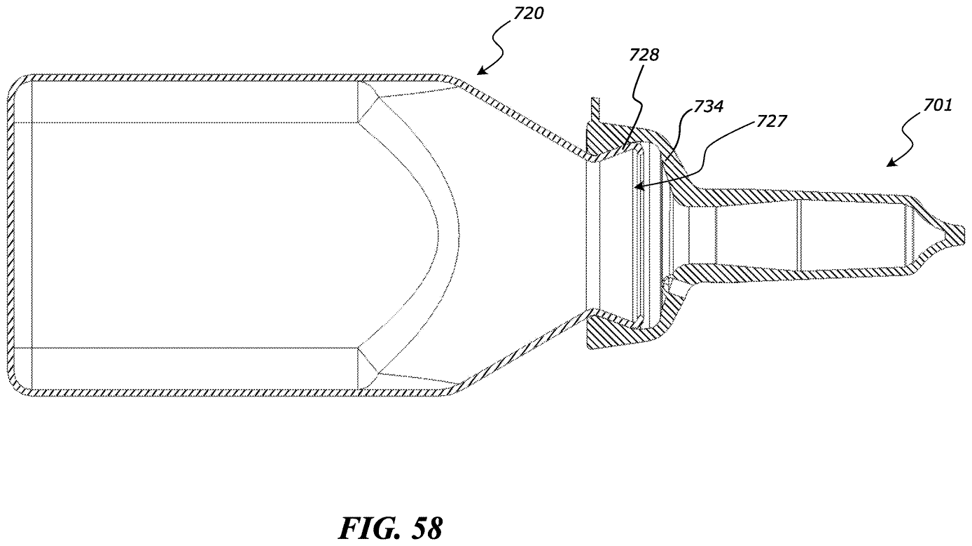

As shown in FIG. 58, the liquid reservoir 720 may comprise a bottle having the spout 727. The spout 727 may project from a neck region of the liquid reservoir 720. The base 706 of the artificial feeding teat 701 may be pushed over the spout 727 so that the base 706 surrounds the spout 727 and the inlet opening 709 communicates with the spout 727. The snap-fit engagement between the base 706 and the spout 727 may retain the artificial feeding teat 701 on the liquid reservoir 720 during feeding. The liquid reservoir 720 may be flexible so that a user can squeeze the liquid reservoir 720 to urge liquid through the spout 727, through the duct 703, and toward the closeable opening 714 of the nipple 710.

In some embodiments, the artificial feeding teat 701 is removable from the spout 727 by pulling the base 706 away from the spout 727 with sufficient force to elastically deform the base 706 and release the internal retaining formation 732 from the complementary retaining formation 728. The knurled exterior region 740 may assist the user in gripping the base 706 during removal. In other embodiments, the tab 742 may assist removal by providing a local portion that can be pulled or lifted to initiate deformation of the base 706 relative to the spout 727.

The knurled exterior region 740 may have different configurations. In some embodiments, the peripheral ribs 741 are straight ribs. In some embodiments, the peripheral ribs 741 are rounded ribs. In some embodiments, the peripheral ribs 741 are separated by grooves extending along the base 706. In some embodiments, the peripheral ribs 741 are continuous along the axial length of the knurled exterior region 740. In some embodiments, the peripheral ribs 741 are interrupted by one or more gaps. In some embodiments, the peripheral ribs 741 extend parallel to the elongate axis XX. In other embodiments, the peripheral ribs 741 may extend at an angle to the elongate axis XX or may comprise crossing rib portions.

The artificial feeding teat 701 may include any suitable closeable opening 714 at the nipple 710. In some embodiments, the closeable opening 714 comprises a slit. In some embodiments, the closeable opening 714 comprises a tip slit. In some embodiments, the closeable opening 714 comprises another closeable opening arrangement described herein. The knurled base and snap-fit features described with reference to FIGS. 50 to 58 may be used independently of the non-round base features and independently of the concave nipple slit-sealing features described elsewhere in this specification, unless a claim expressly requires a combination of such features.

In some embodiments, the artificial feeding teat may comprise a shaft wall having a wall thickness that increases toward the base of the artificial feeding teat. In some embodiments, the increasing wall thickness may be provided by a tapering internal surface of the wall of the shaft while an exterior surface of the teat remains substantially continuous or substantially untapered. In other embodiments, the increasing wall thickness may be provided by a change in the exterior profile of the teat, a change in the interior profile of the duct, or both.

In the example of FIG. 49, the thickened wall portion 683 associated with the tapering portion 681 increases in thickness toward the base 6. The thickened wall portion 683 may reduce flexibility of the artificial feeding teat near the base 6 relative to a more forward portion of the teat near the nipple 10. This may encourage an animal to position its mouth further forward on the artificial feeding teat during feeding, for example further forward on the milk chamber and closer to the nipple 10. The more forward portion of the artificial feeding teat may remain relatively softer or more flexible than the region near the base 6, which may assist feeding by younger animals while the thicker region near the base 6 improves resistance to deformation, chewing, biting, or other damage caused by older or stronger animals.

In some embodiments, the artificial feeding teat 701 shown in FIGS. 50 to 58 may similarly comprise shaft wall having a wall thickness that increases toward the base 706. For example, the shaft 702 or a transition portion between the shaft 702 and the base 706 may have a thicker wall nearer the base 706 than nearer the nipple 710. The thicker wall nearer the base 706 may provide increased robustness in a region of the artificial feeding teat 701 that may be gripped, compressed, or damaged during installation, removal, or feeding. The relatively thinner or more flexible wall nearer the nipple 710 may maintain a softer front portion of the artificial feeding teat 701 for oral engagement by younger animals.

The increasing wall thickness near the base may be used independently of the particular base configuration, nipple configuration, or reservoir interface configuration. For example, the increasing wall thickness may be used with a non-round base configured to control rotational orientation of the artificial feeding teat, with a nipple having a concave exterior surface profile configured to enhance sealing of a slit, with a knurled exterior region of a base configured to facilitate push-on snap-fit engagement with a spout, or with another artificial feeding teat configuration. Unless expressly required by a claim, the increasing wall thickness need not be combined with any particular closeable opening, any particular slit orientation, any particular snap-fit engagement, or any particular non-circular base geometry.

In some embodiments, the wall thickness increases progressively toward the base. In some embodiments, the wall thickness increases stepwise toward the base. In some embodiments, the wall thickness increases continuously along at least part of the shaft. In some embodiments, the thickness increases only along a selected portion of the shaft adjacent the base. In some embodiments, the wall thickness nearer the base is greater than the wall thickness nearer the nipple by an amount sufficient to provide greater resistance to animal-induced damage near the base while maintaining greater flexibility nearer the nipple.

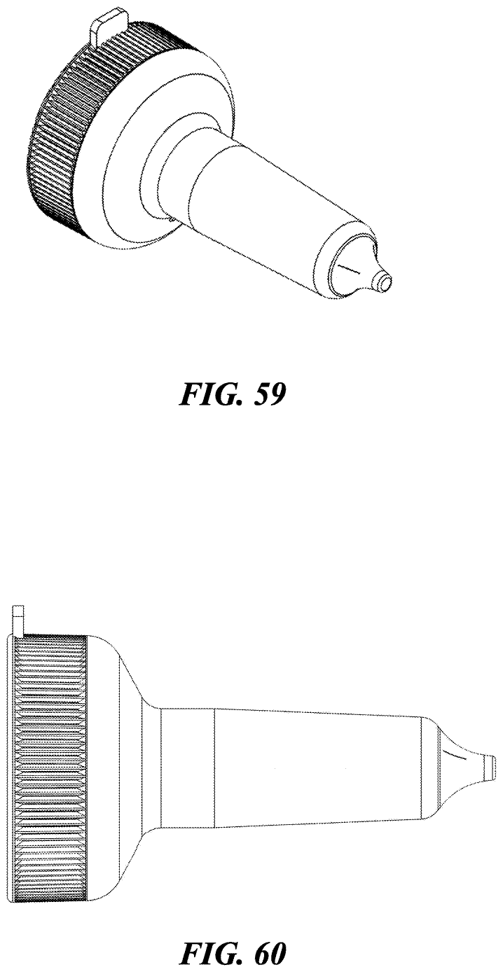

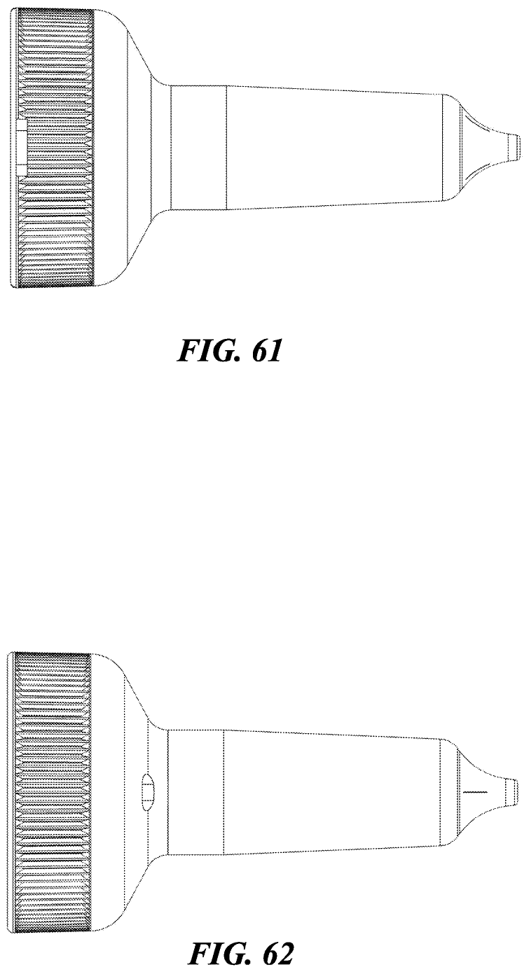

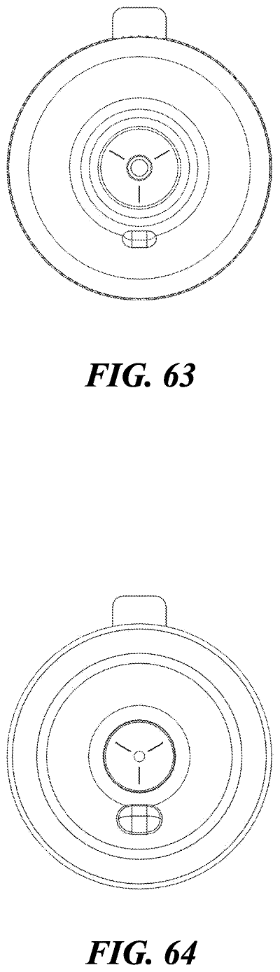

FIGS. 59-64 illustrate a design of an artificial feeding teat equivalent to that described in FIGS. 50-58.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. An artificial feeding teat for ducting a liquid from a liquid reservoir to an animal for oral consumption of the liquid by the animal, the feeding teat comprising:
a shaft with an elongate straight axis, the shaft is hollow to define a duct for said liquid to flow through;
a base located at a first distal end of the shaft and defining an inlet opening to the duct;
a nipple located at a second distal end opposite the first distal end, the nipple has a nipple wall to define a closure to the duct at the end of the second distal end of the shaft, save for at least one closeable opening through the nipple wall;
wherein the base defines a peripheral seal that is configured to releasably engage with a seat defined at an opening to a liquid reservoir to allow a sealed ducting of the liquid from the reservoir though the opening and into the duct; and
wherein the interface of the teat and reservoir is configured to prevent clockwise and anti-clockwise rotation of the feeding teat about the axis when the base is engaged to the reservoir;
wherein the peripheral seal comprises a peripheral surface which engages with a corresponding peripheral surface of the seat;
wherein the peripheral surface comprises a non-circular geometry having one or two lines of symmetry in a cross-sectional plane to which the axis in normal and is adapted to engage with a complementary non-circular geometry of the peripheral surface of the seat;
wherein the closable opening comprises an elongate slit extending in another cross-sectional plane to which the axis is normal; and
wherein the interface is configured to secure the elongate slit at a predetermined rotational position about the axis when the base is engaged to the reservoir.

2. A feeding teat as claimed in claim 1, wherein the peripheral surface comprises a longitudinal surface extending substantially parallel to the axis and perimetrically around the teat to engage with a corresponding longitudinal surface of the seat.

3. A feeding teat as claimed in claim 2, wherein the peripheral surface comprises a radial surface extending radially from an end of the longitudinal surface to engage with a corresponding radial surface of the seat.

4. A feeding teat as claimed in claim 3, wherein the peripheral surface comprises a second radial surface extending radially from the other end of the longitudinal surface to engage with a corresponding second radial surface of the seat.

5. A feeding teat as claimed in claim1, wherein the interface is configured to secure the elongate slit substantially vertically when the base is engaged to the reservoir.

6. A feeding teat as claimed in any one preceding claim, wherein the non-circular geometry comprises one of the following shapes: rectangle; rounded rectangle; semi-circle;
ellipse; triangle; trapezoid; parallelogram; a circle save for at least one straight line edge; a spline; a keyway.

7. A feeding teat according to claim 1, wherein the interface of the seal and seat is a keyed interface.

8. A feeding teat as claimed in claim 1, wherein the seal comprises at least one ridge or groove extending parallel to the axis and adapted to engage with a complementary groove or ridge in the seat.

9. A feeding teat as claimed in claim 1, wherein the teat comprises a projection or recess adjacent the seal and radially spaced from the axis and adapted to engage with a complementary recess or projection of the reservoir.

10. A feeding teat as claimed in claim 9, wherein the projection and recess are configured to engage using a keyed interface.

11. A feeding teat as claimed in claim 1, wherein the closeable opening through the nipple wall is deformable between i. a natural state where the nipple wall at the opening compressively seals the opening, and ii. a deformed state that creates an opening through the nipple wall via which liquid can pass from the duct to the animal.

12. A feeding teat as claimed in claim 1, having a second closeable opening comprising a second slit which extends in a second direction parallel to a second plane passing through the axis, and wherein a component of the first and second direction perpendicular to the axis are substantially colinear.

13. A feeding teat as claimed in claim 1, wherein the interface is configured to align a component of the or each slit perpendicular to the axis such that the component is coextensive with a predetermined radial of the axis when the base is engaged to the reservoir.

14. An artificial feeding teat for ducting a liquid from a liquid reservoir to an animal for oral consumption of the liquid by the animal, the artificial feeding teat comprising:
a shaft with an elongate straight axis, the shaft being hollow to define a duct for the liquid to flow through;
a base located at a first distal end of the shaft and defining an inlet opening to the duct; and
a nipple of an elastomeric material located at a second distal end opposite the first distal end, the nipple having a nipple wall to define a closure to the duct at the second distal end of the shaft, save for at least one closeable opening comprising a slit through the nipple wall, the closeable opening being deformable between a natural state where the nipple wall at the slit compressively seals the closeable opening and a deformed state that creates an opening through the nipple wall via which liquid can pass from the duct to the animal;
wherein, the slit is located at a region of the nipple wall that will become more compressed when pressure inside the duct is increased to enhance the compressive sealing of the closeable opening; and
wherein, when seen in a cross-sectional plane with which the elongate straight axis is coextensive, the region of the nipple wall at which the slit is located comprises a concave exterior surface profile that extends substantially parallel to the elongate straight axis.

15. The artificial feeding teat of claim 14, wherein, when seen in the cross-sectional plane with which the elongate axis is coextensive, the region of the nipple wall at which the slit is located includes no convex exterior surface profile.

16. The artificial feeding teat of claim 14, wherein the concave exterior surface profile is configured to change profile to be less concave when pressure inside the duct is increased.

17. The artificial feeding teat of claim 14, wherein the slit extends in a direction parallel to the elongate axis.

18. The artificial feeding teat of claim 17, wherein the slit is of a length that is less than a height of the nipple in a direction of the elongate axis.

19. The artificial feeding teat of claim 14 wherein, in a cross-sectional plane to which the elongate axis is normal, the shaft is of a circular exterior shape.

20. The artificial feeding teat of claim 19, wherein, in the cross-sectional plane to which the elongate axis is normal, the shaft is of the circular exterior shape and of a constant cross section along its length.
